(19) United States
(12) Patent Application Publication
(10) Pub. No.: US 2003/0026267 A1
(43) Pub. Date: Feb. 6, 2003

(54) Virtual channels in a network switch

(76) Inventors: Stuart F. Oberman, Sunnyvale, CA (US); Anil Mehta, Milpitas, CA (US); Rodney N. Mullendore, San Jose, CA (US); Kamran Malik, San Jose, CA (US); Keith Schakel, San Jose, CA (US)

Correspondence Address: Robert C. Kowert, Conley, Rose & Tayon, P.C., P.O. Box 398, Austin, TX, 78767, US

(21) Appl. No.: 10/164,250

(22) Filed: Jun. 5, 2002

Related U.S. Application Data
(60) Provisional application No. 60/309,032, filed on Jul. 31, 2001.

(51) Int. Cl. H04L 12/28; H04L 12/56

(52) U.S. Cl. 370/397; 370/400

(57) ABSTRACT

A system and method providing virtual channels with credit-based flow control on links between network switches. A network switch may include multiple input ports, multiple output ports, and a shared random access memory coupled to the input ports and output ports by data transport logic. Two network switches may go through a login procedure to determine if virtual channels may be established on a link. A credit initialization procedure may be performed to establish the number of credits available to the virtual channels. Credit-based packet flow may then begin on the link. A credit synchronization procedure may be performed to prevent the loss of credits due to errors. On detecting certain error conditions, a virtual channel may be deactivated. In one embodiment, the link is a Gigabit Ethernet link, and the packets are Gigabit Ethernet packets. The packets may encapsulate storage format (e.g. Fiber Channel) frames.

### CROSS-REFERENCE TO RELATED APPLICATIONS

This application claims the benefit of U.S. Provisional Application No. 60/309,032, filed Jul. 31, 2001.

### BACKGROUND OF THE INVENTION

1. Field of the Invention

The present invention generally relates to the field of network switches. More particularly, the present invention relates to a system and method for providing virtual channels over links between network switches.

2. Description of the Related Art

In enterprise computing environments, it is desirable and beneficial to have multiple servers able to directly access multiple storage devices to support high-bandwidth data transfers, system expansion, modularity, configuration flexibility, and optimization of resources. In conventional computing environments, such access is typically provided via file system level Local Area Network (LAN) connections, which operate at a fraction of the speed of direct storage connections. As such, access to storage systems is highly susceptible to bottlenecks.

Storage Area Networks (SANs) have been proposed as one method of solving this storage access bottleneck problem. By applying the networking paradigm to storage devices, SANs enable increased connectivity and bandwidth, sharing of resources, and configuration flexibility. The current SAN paradigm assumes that the entire network is constructed using Fibre Channel switches. Therefore, most solutions involving SANs require implementation of separate networks: one to support the normal LAN and another to support the SAN. The installation of new equipment and technology, such as new equipment at the storage device level (Fibre Channel interfaces), the host/server level (Fibre Channel adapter cards) and the transport level (Fibre Channel hubs, switches and routers), into a mission-critical enterprise computing environment could be described as less than desirable for data center managers, as it involves replication of network infrastructure, new technologies (i.e., Fibre Channel), and new training for personnel. Most companies have already invested significant amounts of money constructing and maintaining their network (e.g., based on Ethernet and/or ATM). Construction of a second high-speed network based on a different technology is a significant impediment to the proliferation of SANs. Therefore, a need exists for a method and apparatus that can alleviate problems with access to storage devices by multiple hosts, while retaining current equipment and network infrastructures, and minimizing the need for additional training for data center personnel.

In general, a majority of storage devices currently use “parallel” SCSI (Small Computer System Interface) or Fibre Channel data transfer protocols whereas most LANs use an Ethernet protocol, such as Gigabit Ethernet. SCSI, Fibre Channel and Ethernet are protocols for data transfer, each of which uses a different individual format for data transfer. For example, SCSI commands were designed to be implemented over a parallel bus architecture and therefore are not packetized. Fibre Channel, like Ethernet, uses a serial interface with data transferred in packets. However, the physical interface and packet formats between Fibre Channel and Ethernet are not compatible. Gigabit Ethernet was designed to be compatible with existing Ethernet infrastructures and is therefore based on an Ethernet packet architecture. Because of these differences there is a need for a new system and method to allow efficient communication between the three protocols.

One such system and method is described in the United States Patent Application titled “METHOD AND APPARATUS FOR TRANSFERRING DATA BETWEEN IP NETWORK DEVICES AND SCSI AND FIBRE CHANNEL DEVICES OVER AN IP NETWORK” by Latif, et al., filed on Feb. 8, 2000 (Ser. No. 09/500,119). This application is hereby incorporated by reference in its entirety. This application describes a network switch that implements a protocol referred to herein as Storage over Internet Protocol (SoIP).

Flow control is the management of data flow between computers or devices or between nodes in a network so that the data can be handled at an efficient pace. Too much data arriving before a device can handle it causes data overflow, meaning the data is either lost or must be retransmitted. For serial data transmission locally or in a network, an Xon/Xoff protocol using special control frames can be used. In a network, flow control can also be applied by refusing additional device connections until the flow of traffic has subsided.

Fibre Channel and Ethernet protocols (e.g. Gigabit Ethernet) use different methods of flow control to ensure that data frames (e.g. packets) are not lost. Ethernet typically uses an Xon/Xoff protocol with special control frames to implement flow control while Fibre Channel uses a credit-based method.

In full duplex Gigabit Ethernet using flow control, when an input port no longer wishes to receive data, a special control frame known as a pause frame is transmitted on the output port. The pause frame includes the amount of time (pause-time parameter) that the transmitter at the other end of the link should delay before continuing to transmit packets (i.e. the amount of time to “pause”). The link can be re-enabled by sending a pause frame with a time of 0.

Because multiple storage packet flows may need to be sent over a single Ethernet link, it is desirable to provide a network switch that supports the multiple flows in a manner that prevents one flow from blocking other flows, and that equitably distributes resources among the various flows. It is also desirable to provide a network switch that supports ingress packet flows, egress packet flows, and a combination of ingress and egress packet flows. A packet is a unit of data that is routed between an origin and a destination on the Internet or any other packet-switched network. In general, the terms “packet flow” and “flow” as used herein include the notion of a stream of one or more packets sent from an origin to a destination or, in the case of multicast, to multiple destinations.

In general, it is desirable to virtually never drop storage packets (e.g. SoIP packets) in a SAN. Since storage packets such as SoIP packets are carrying storage format frames (e.g. Fibre Channel packets) that typically use credit-based flow control, it may be desirable to support credit-based flow control for storage packet flows on links between network switches.

Because of unreliable communication (bit errors may eventually occur), packets on a link may be corrupted and as such “lost”. If packets that include credit information become corrupted, credits may be lost, potentially resulting in a deterioration of transmission rate. Eventually, if all the credits are lost, transmission of packets over the link will stop. Fiber Channel Arbitrated Loop (FC-AL) avoids this problem by refreshing the credits to the initial number every time a port is opened. Fibre channel point-to-point connection has no specific mechanism to do this, other than the credits being refreshed when the port gets into an “error” state. In order to avoid this problem, it is desirable to provide a credit synchronization procedure for network switches implementing credit-based flow control for storage packet flows on links between the switches.

### SUMMARY

The problems set forth above may at least in part be solved by a system and method for providing virtual channels with credit-based flow control on network links between network switches, particularly when applied to Storage Area Networks (SANs) that support Storage over Internet Protocol (SoIP).

Embodiments of network switches as described herein may be incorporated into a Storage Area Network (SAN) that comprises multiple data transport mechanisms and thus supports multiple data transport protocols. These protocols may include SCSI, Fibre Channel, Ethernet and Gigabit Ethernet. Because storage format frames (e.g. Fibre Channel) may not be directly compatible with an Ethernet transport mechanism such as Gigabit Ethernet, the transmission of storage packets on an Ethernet such as Gigabit Ethernet may require that a storage frame be encapsulated in an Ethernet frame. In general, an Ethernet frame encapsulating a storage frame may be referred to as a “storage packet.” One embodiment of a storage packet protocol that may be used for Gigabit Ethernet is Storage over Internet Protocol (SoIP). Other storage packet protocols are possible and contemplated. Thus, some embodiments of network switches as described herein support sending and receiving storage packets such as SoIP packets. Note that non-storage packets may be referred to herein simply as “IP packets.” Since both IP and storage packets may be transported over the same link, a method is provided for marking Gigabit Ethernet packets to distinguish between packets subject to credit-based flow control and standard IP packets not subject to credit-based flow control.

In general, it is desirable to virtually never drop a storage packet. Since storage packets are carrying storage format frames (e.g. Fibre Channel packets), it may be desirable to support credit-based flow control for Gigabit Ethernet packets. Thus, a novel credit-based flow control method for Gigabit Ethernet packets is described herein that supports storage packet flows such as SoIP packet flows. A packet is a unit of data that is routed between an origin and a destination on the Internet or any other packet-switched network. In general, the terms “packet flow” and “flow” as used herein include the notion of a stream of one or more packets sent from an origin to a destination or, in the case of multicast, to multiple destinations. The credit-based flow control method may also be applied to non-storage Gigabit Ethernet packet flows, and in general to packet flows in any Ethernet protocol, if is desirable to perform credit-based flow control to guarantee that packets will not be dropped.

Embodiments of a network switch are described herein that implement credit-based flow control for Gigabit Ethernet packets and SoIP packets on virtual channels over inter-switch Gigabit Ethernet links. The credit-based flow control method, when implemented on an embodiment of a network switch, may be used in supporting egress (outgoing) packet flows and ingress (incoming) packet flows on one or more virtual channels of the network switch. In addition to standard Gigabit Ethernet IP packet flow (with and without pause-based flow control) up to K virtual channel based packet flows may be supported on a single Gigabit Ethernet link. Note that virtual channels and credit-based flow control of virtual channels as described herein may be applied to other network implementations such as Ethernet and Asynchronous Transfer Mode (ATM). For example, embodiments of network switches may support virtual channels using credit-based flow control for Ethernet packets including Ethernet IP packets and storage packets on inter-switch Ethernet links.

Preferably, a virtual channel cannot block any of the other virtual channels. In one embodiment, credit-based flow control may be applied to each active virtual channel separately, and separate credit count information may be kept for each virtual channel. Thus, up to K separate “conversations” may be simultaneously occurring on one Gigabit Ethernet link, with one conversation on each virtual channel, and with K different sets of resources being tracked for each virtual channel's credit-based flow control.

In one embodiment, virtual channel packet flow is built on the concept of credits. When a link is established on a switch (separately in the egress and ingress directions), the number of virtual channels that the link will support and the maximum packet size in bytes that may be transferred on the virtual channels of the link are determined. Having established this, the number of credits (in multiples of packet size where one packet is one credit) that will be supported on the link in the ingress direction is determined (which corresponds to the egress direction for the switch on the opposite end of the link). Note that it is not required that virtual channels exist in both ingress and egress directions on a link.

The network switch allocates clusters and packets to the active virtual channels on the link. If standard Gigabit Ethernet packet flow is also expected on the link, then the network switch may also allocate clusters and packets to threshold groups for input thresholding the incoming IP packets. Incoming packets may be assigned to one of the active virtual channels by the transmitting port, or the packets may be assigned to a threshold group and have a flow number assigned to them by the Network Processor of the receiving port, depending on the type of packet (e.g. storage packet or IP packet).

When establishing virtual channels on a link between network switches, the network switches may first go through a login procedure to determine if virtual channels may be established. In one embodiment, each network switch comprises a GEMAC (Gigabit Ethernet Media Access Control), which is logic that is configurable to couple a port of the network switch to a Gigabit Ethernet. The GEMAC and port in combination may be referred to as a Gigabit Ethernet port. In one embodiment, on power-up of the network switch, a Gigabit Ethernet port of a first network switch (receiver) may try and establish if a corresponding port on a second network switch (transmitter) is virtual channel capable. In one embodiment, this may be performed by the management CPU of the receiver network switch by first setting up the port as a standard Gigabit Ethernet port (with or without flow control). Then, a number of virtual channel parameters may be set in configuration registers, and the GEMAC (Gigabit Ethernet Media Access Control) may be enabled for the port to try and establish contact with the switch on the other end for virtual channel-based packet flow. In one embodiment, this is done by sending a login frame to the transmitter port.

If the login procedure establishes that the switch is a virtual channel-capable switch and is interested in establishing virtual channels on the link, then a credit initialization procedure may be performed. The network switch may attempt to establish the number of credits that it wants to give the transmitting port via a credit initialization frame. If this is successful, then the port is configured for virtual channel-based packet flow, and credit-based packet flow with credit synchronization is started.

As virtual channel tagged packets flow into a switch, credits get used up. Once these packets leave the switch, the credits become available for further packet flow into the switch. This information, which may be referred to as virtual channel readys (VCRDYs), may be transferred to the transmitting port via virtual channel ready frames. This may be done either via special frames sent to the transmitter or by the information being piggybacked onto existing frames going to the transmitter.

It is possible that finite bit error rates may sometimes produce unreliable communication links. On an unreliable communication link, frames carrying information about VCRDYs may be corrupted, and as such the VCRDY information may be effectively “lost”. In one embodiment, to recover lost VCRDYs (and as such credit) a credit synchronization method using credit synchronization frames may be used.

On the detection of certain error conditions during login, credit initialization or credit synchronization, the management CPU may want to deactivate the virtual channels. In one embodiment, a deactivation message may be sent. This message may be sent one or more times with a programmed delay value. No acknowledgement is expected. After sending the last message, the link may either be deactivated or may revert back to a standard Gigabit Ethernet link.

In one embodiment, a network switch configured to support virtual channels with credit-based flow control on a link may comprise a number of input ports, a number of output ports, a memory, and data transport logic coupled between the input ports, the output ports, and the memory. In one embodiment, the network switch may comprise one or more chips or slices, each of which includes support for a subset of the ports of the network switch. The input ports may be configured to receive data forming a packet, wherein the packet may have a destination that corresponds to one or more of the output ports. The network switch may include a shared memory that may be a random access memory (e.g., an SRAM, SDRAM, or RDRAM). In some embodiments, the network switch may be configured to allocate storage within the shared memory using portions of memory referred to herein as cells. As used herein, a cell may be defined as a memory portion including the minimum number of bytes that can be read from or written to the shared memory (e.g., 512 bits or 64 bytes). The cell size is a function of the memory interface with the shared memory. However, in some embodiments, a number of cells (e.g., two cells) may be grouped and defined as a “cluster”. Clusters may be used to reduce the number of bits required for tracking and managing packets.

The switch may also comprise one or more network processors configured to add an Ethernet prefix to received Fibre Channel packets in response to detecting that the Fibre Channel packets are being routed to an Ethernet output port. While different configurations are possible and contemplated, in one embodiment of a network switch, the input and output ports are either Fibre Channel or Gigabit Ethernet ports.

### BRIEF DESCRIPTION OF THE DRAWINGS

The foregoing, as well as other objects, features, and advantages of this invention may be more completely understood by reference to the following detailed description when read together with the accompanying drawings in which:

FIG. 1 is a block diagram of a portion of one embodiment of a network switch fabric;

FIG. 2 illustrates details of one embodiment of a packet descriptor;

FIG. 3 illustrates details of one embodiment of the cluster link memory, packet free queue, and packet descriptor memory from FIG. 1;

FIG. 4 illustrates details of one embodiment of the queue descriptor memory and queue link memory from FIG. 1;

FIG. 5 is a diagram illustrating one embodiment of the structure of the input FIFO from FIG. 1;

FIG. 6 illustrates one embodiment of a set of pointers that may be used in connection with the input FIFO of FIG. 1;

FIG. 7 illustrates one embodiment of a state machine that may be used to operate the input FIFO from FIG. 1;

FIG. 8 is a diagram illustrating details of one embodiment of multiplexing logic within the data transport block of FIG. 1;

FIG. 9 illustrates details of one type of address bus configuration that may be used with the shared memory (RAM) of FIG. 1;

FIG. 10 illustrates one embodiment of a cell assembly queue within the data transport block of FIG. 1;

FIG. 11 is a diagram illustrating one embodiment of a cell disassembly queue;

FIG. 12 is a data flow diagram for one embodiment of the data transport block from FIG. 1;

FIG. 13 illustrates a field that defines the current operating mode of a port according to one embodiment;

FIG. 14 is a table summarizing various aspects of port modes, fabric resource tracking and the conditions in which packets may be dropped according to one embodiment;

FIG. 15 illustrates multiple levels of thresholding for controlling resource allocation according to one embodiment;

FIG. 16 illustrates a Storage over Internet Protocol (SoIP) packet format according to one embodiment;

FIG. 17 is a block diagram illustrating Gigabit Ethernet virtual channels between two network switches according to one embodiment;

FIG. 18 illustrates a method for establishing, maintaining and deactivating credit-based flow control on virtual channels in a network switch according to one embodiment;

FIG. 19 is a table illustrating virtual channel based credit flow through several cycles according to one embodiment;

FIG. 20 illustrates a generic MAC Control frame according to one embodiment;

FIG. 21 illustrates a format for a pause frame according to one embodiment;

FIG. 22 lists examples of opcodes that may be defined for network switch-specific usage according to one embodiment;

FIG. 23a illustrates a login frame format according to one embodiment;

FIG. 23b illustrates a login acknowledgement frame format according to one embodiment;

FIG. 24a illustrates a credit initialization frame format according to one embodiment;

FIG. 24b illustrates a credit initialization acknowledgement frame format according to one embodiment;

FIG. 25 illustrates a virtual channel ready frame format according to one embodiment;

FIG. 26a illustrates a Credit synchronization frame format according to one embodiment;

FIG. 26b illustrates a credit synchronization acknowledgement frame format according to one embodiment;

FIG. 27 illustrates a deactivation frame format according to one embodiment;

FIG. 28 illustrates Gigabit Ethernet virtual channel frame according to one embodiment;

FIG. 29 illustrates piggybacking credit information onto a Gigabit Ethernet frame according to one embodiment; and

FIG. 30 is a block diagram of the output scheduler architecture according to one embodiment.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION OF SEVERAL EMBODIMENTS

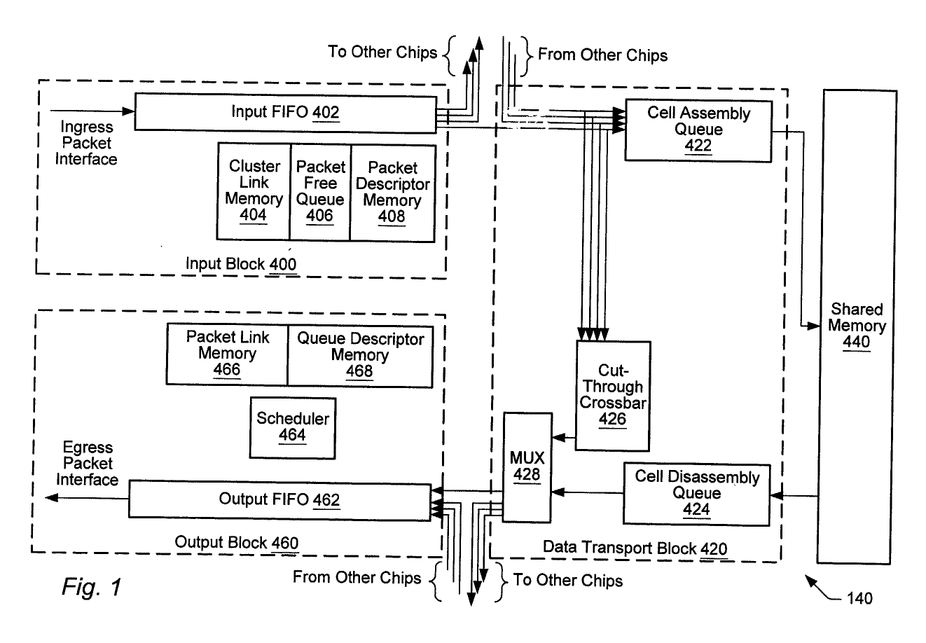

Turning now to FIG. 1, a block diagram of a portion of one embodiment of a network switch fabric is shown. In this embodiment, switch fabric portion 140 comprises an input block 400 (also referred to as an ingress block), a data transport block 420, a shared memory 440, and an output block 460 (also referred to as an egress block). The switch fabric may comprise a plurality of switch fabric portions 140 (e.g., 4 or 8 portions, each having one input port and one output port). In one embodiment, input block 400, data transport block 420 and output block 460 are all implemented on a single chip (e.g., an application specific integrated circuit or ASIC). The switch fabric may include one or more input blocks 400, wherein each input block 400 is configured to receive internal format packet data (also referred to as frames), from which it is then written into an input FIFO 402. Input block 400 may be configured to generate packet descriptors for the packet data and allocate storage within shared memory (i.e., RAM) 440. As will be described in greater detail below, the switch fabric may route the packet data in a number of different ways, including a store-and-forward technique, an early forwarding technique, and a cut-through routing technique.

Input block 400 may further comprise a cluster link memory 404, a packet free queue 406, and a packet descriptor memory 408. Cluster link memory 404 may be configured as a linked list memory to store incoming packets. Packet free queue 406 is configured to operate as a “free list” to specify which memory locations are available for storing newly received packets. In some embodiments, input block 400 may be configured to allocate storage within shared memory 440 using cells. In this embodiment, a cell is the minimum number of bytes that can be read from or written to shared memory 440 (e.g., 512 bits or 64 bytes). The cell size is a function of the interface with shared memory 440. However, in some embodiments, a number of cells (e.g., two cells) may be defined as a “cluster”. Clusters may be used to reduce the number of bits required for tracking and managing packets. Advantageously, by dividing packets into clusters instead of cells, the overhead for each packet may potentially be reduced. For example, in one embodiment shared memory 440 may allocate memory in 128-byte clusters. The cluster size may be selected based on a number of factors, including the size of shared memory 440, the average and maximum packet size, and the size of packet descriptor memory 408. However, the potential disadvantage is that a small packet that would normally fit within a single cell will nevertheless be assigned an entire cluster (i.e., effectively wasting a cell). While this is a design choice, if the number of small packets is low relative to the number of large packets, the savings may outweigh the disadvantages. In some embodiments, clusters may not be used.

Upon receiving packet data corresponding to a new packet, input block 400 may be configured to allocate clusters in shared memory 440 (using cluster link memory 404) and a packet descriptor to the new packet. Packet descriptors are entries in packet descriptor memory 408 that contain information about the packet. One example of information contained within a packet descriptor may include pointers to which clusters in shared memory 440 store data corresponding to the packet. Other examples may include format information about the packet (e.g., the packet length, if known), and the destination ports for the packet.

In the embodiment of switch fabric 140 shown in FIG. 1, data transport block 420 includes cell assembly queues 422, cell disassembly queues 424, cut-through crossbar switch 426, and multiplexer 428. Cell assembly queues 422 are configured to receive packets from input block 400 and store them in shared memory 440. In one embodiment, cell assembly queues 422 may operate as FIFO memories combined with a memory controller to control the storage of the packets into shared memory 440. Cut-through crossbar 426 is configured to connect selected inputs and outputs together in cooperation with multiplexer 428. Advantageously, this may allow cut-through routing of packets, as explained in greater detail below.

In some embodiments, switch fabric 140 may be implemented using multiple chips that operate in parallel. In these configurations, cell assembly queue 422 and cell disassembly queue 424 may operate as serial-to-parallel and parallel-to-serial converters, respectively. For example, in an implementation having four switch fabric chips, as a particular 4-byte word is received, input FIFO 402 may be configured to distribute the 4-byte word amongst the four chips (i.e., one byte per chip) with one byte going to each chip's data transport block 420. Once 16 bytes have been received in each chip's cell assembly queue 422, the 64-byte cell may be stored to shared memory 440. Similarly, assuming a 128-bit data interface between shared memory 440 and the four switch fabric chips 140, a 64-byte cell may be read from shared memory 440 in four 16-byte pieces (i.e., one piece per chip), and then converted back into a single serial stream of bytes that may be output one byte per clock cycle by output FIFO 462.

Shared memory 440 may have write ports that are coupled to cell assembly queues 422, and read ports coupled to cell disassembly queues 424. In one embodiment, switch fabric 140 may support multiple ports for input and output, and switch fabric 140 may also be configured to perform bit-slice-like storage across different banks of shared memory 440. In one embodiment, each switch fabric 140 may be configured to access only a portion of shared memory 440. For example, each switch fabric may be configured to access only 2 megabytes of shared memory 440, which may have a total size of 8 megabytes for a 16-port switch. In some embodiments, multiple switch fabrics may be used in combination to implement switches supporting larger numbers of ports. For example, in one embodiment each switch fabric chip may support four full duplex ports. Thus, two switch fabric chips may be used in combination to support an eight-port switch. Other configurations are also possible, e.g., a four-chip configuration supporting a sixteen-port switch.

Output bock 460 comprises output FIFO 462, scheduler 464, queue link memory 466, and queue descriptor memory 468. Output FIFO 462 is configured to store data received from shared memory 440 or from cut-through crossbar 426. Output FIFO 462 may be configured to store the data until the data forms an entire packet, at which point scheduler 464 is configured to output the packet. In another embodiment, output FIFO 462 may be configured to store the data until at least a predetermined amount has been received. Once the predetermined threshold amount has been received, then output FIFO 462 may begin forwarding the data despite not yet having received the entire packet. This is possible because the data is being conveyed to output FIFO 462 at a fixed rate. Thus, after a predetermined amount of data has been received, the data may be forwarded without fear of underflow because the remaining data will be received in output FIFO 462 before an underflow can occur. Queue link memory 466 and queue descriptor memory 468 are configured to assist scheduler 464 in reassembling packets in output FIFO 462.

Data that can be cut-through is routed directly through cut-through crossbar logic 426 and multiplexer 428 to the output FIFO 462, and then to the egress packet interface (e.g., a 16-bit output interface). Packets that cannot be cut-through are stored in shared memory 440. These packets are added to one of several output queues. An internal scheduler selects packets from the various queues for transmission to an output port. The packet is read from the SRAM, passed through the output FIFO, and then sent to the egress packet interface. The ingress and egress packet interfaces may include interface logic such as buffers and transceivers, and physical interface devices (e.g., optics modules).

Next, one example of how a packet may be routed in the switch will be described. When a first packet arrives at an input port from the ingress packet interface, it is routed to input FIFO 402 for temporary storage. An entry for the packet is created and stored into packet descriptor memory 408. This new entry is reflected in packet free queue 406, which tracks which of the entries in packet descriptor memory 408 are free. Next, the packet is briefly examined to determine which output port(s) the packet is to be routed to. Note, each packet may be routed to multiple output ports, or to just a single output port. If the packet meets certain criteria for cut-through routing (described in greater detail below), then a cut-through request signal is conveyed to the corresponding output port(s). Each output port that will receive the packet may detect the signal requesting cut-through routing, and each output port makes its own determination as to whether enough resources (e.g., enough storage in output FIFO 462) are available to support cut-through. The criteria for determining whether an output port is available are described in detail below. If the output has the resources, a cut-through grant signal is sent back to the input port to indicate that cut-through is possible. The packet is then routed from input FIFO 402 to the corresponding output port's output FIFO 462 via cut-through crossbar 426.

If one or more of the packet's corresponding output ports are unable to perform cut-through, or if the packet does not meet the requirements for performing cut-through, then the process of writing the packet from input FIFO 402 to shared memory 440 begins. Cell assembly queue 422 effectively performs a serial-to-parallel conversion by dividing the packet into cells and storing the cells into shared memory 440. Information about the clusters allocated to the packet is stored in cluster link memory 404 (i.e., enabling the cells to be read out of shared memory 440 at some future point in time). As noted above, in early forwarding, shared memory 440 operates in a manner somewhat similar to a large FIFO memory. The packet is stored in a linked list of clusters, the order of which is reflected in cluster link memory 404. Independent of the process of writing the packet into shared memory 440, a packet identifier (e.g., a number or tag) is added to one output queue for each corresponding output port that will receive a copy of the packet. Each output port may have a number of output queues. For example, in one embodiment each output port may have 256 output queues. Having a large number of queues allows different priorities to be assigned to queues to implement different types of scheduling such as weighted fair queuing. Adding a packet number to one of these queues is accomplished by updating queue link memory 466 and queue descriptor memory 468. Scheduler 464 is configured to employ some type of weighted fair queuing to select packet numbers from the output queues. As noted above, details of one embodiment of scheduler 464 (also referred to as a scheduling unit) are described in U.S. patent application Ser. No. 09/685,985, titled “System And Method For Scheduling Service For Multiple Queues,” by Oberman, et al., filed on Oct. 10, 2000.

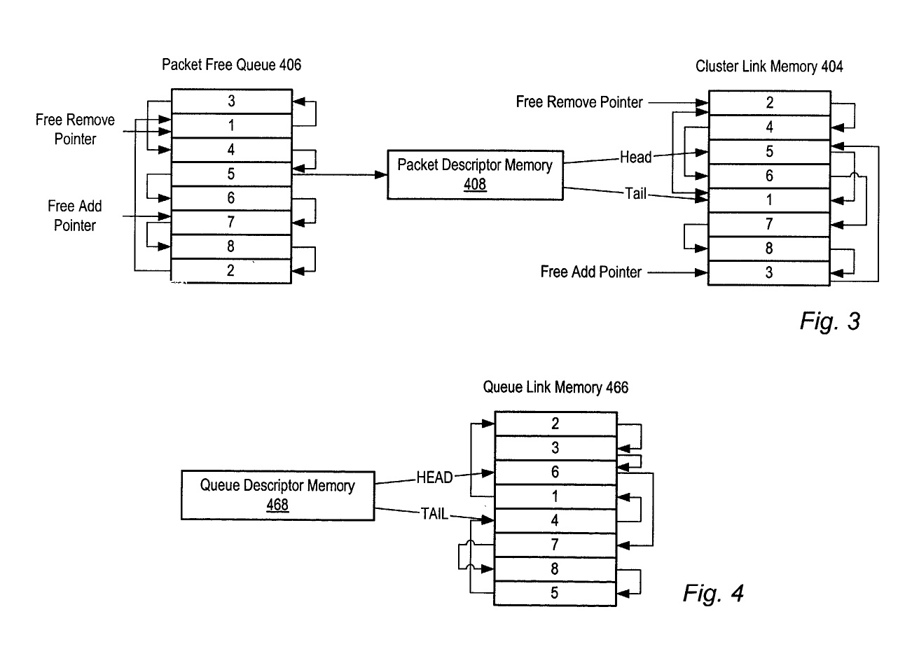

Once a packet number is selected from one of the output queues, the corresponding packet is read from shared memory 440, reformatted into a serial stream from by cell disassembly queue 424, and routed to the corresponding output FIFO 462. From the output FIFO the packet is eventually output to the network through the egress packet interface. However, unless store and forward routing is used (i.e., a worst case scenario from a latency standpoint), the process of reading the packet from shared memory 440 into output FIFO 462 begins before the entire packet has been stored to shared memory 440. In some cases, the process of transferring the packet from shared memory 440 to output FIFO 462 may begin even before the entire packet has been received in input FIFO 402. How soon the output port can begin reading after the input port has started writing depends on a number of different factors that are described in greater detail below. Block diagrams for the main link memories in the input block 400 and output block 460 are shown in FIGS. 3 and 4. More details of input block 400 and output block 460 are also described below.

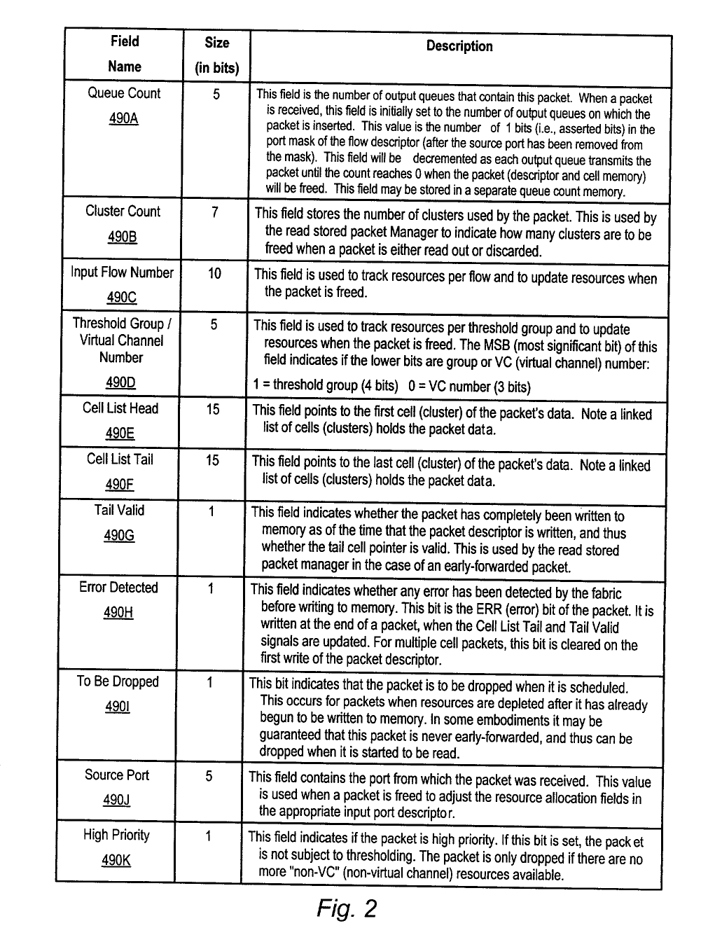

Turning now to FIG. 2, details of one embodiment of a packet descriptor 490 are shown. Note, as used herein a “packet descriptor” is different from a “packet identifier” (also called a “packet number”). While a packet descriptor stores information about a packet, a packet identifier is a number that identifies a particular packet that is being routed by the switch. Additional information may optionally be included in the packet identifier depending on the embodiment. As illustrated in the figure, this embodiment of the packet descriptor includes a queue count field 490A, a cluster count field 490B, an input flow number field 490C, a threshold group/virtual channel number field 490D, a cell list head field 490E, a cell list tail field 490F, a tail valid indicator bit 490G, an error detected indicator bit 489H, an indicator bit for packets that are to be dropped when scheduled 4901, a source port field 490J, and a high priority indicator field 490F. However, other configurations for packet descriptors are also possible and contemplated.

FIG. 3 illustrates details of one embodiment of cell link memory 404, packet free queue 406, and packet descriptor memory 408. As shown in the figure, packet free queue 406 comprises a linked list of pointers to free packet descriptors within packet descriptor memory 408. While different configurations are possible and contemplated, each packet descriptor may comprise a start or head pointer and an end or tail pointer to cluster link memory 404. Cluster link memory may comprise pointers to different memory locations within shared memory 440. In some embodiments, two free pointers (i.e., a free add pointer and a free remove pointer) may be used to access available locations within packet free queue 406. This causes packet free queue to act as a queue as opposed to a stack. This configuration may advantageously yield lower probability of soft errors occurring in times of low utilization when compared with a configuration that utilizes packet free queue 406 as a stack.

FIG. 4 illustrates details of one embodiment of queue descriptor memory 468 and queue link memory 466. Queue descriptor memory 468 may be configured to store pointers indicating the start and end of a linked list in queue link memory 466. Each entry in queue link memory 466 is part of a linked list of pointers to packet numbers for representing packets stored in shared memory 440.

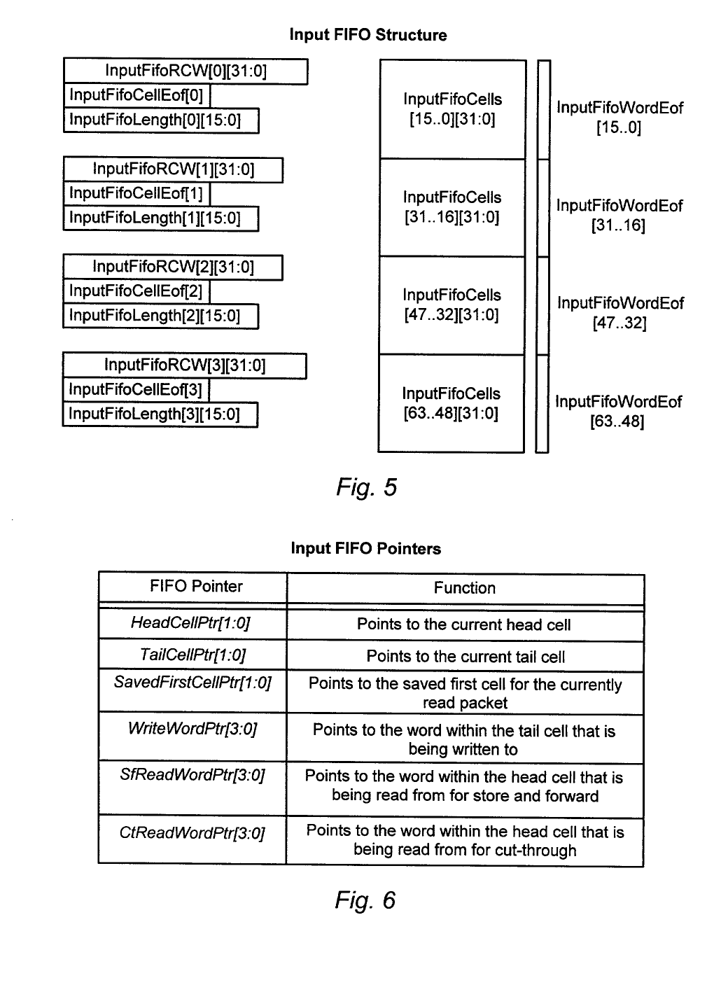

Turning now to FIG. 5, a diagram illustrating one embodiment of the structure of input FIFO 402 is shown. Each input port may have its own input FIFO. The input FIFO may be configured to hold four cells 468A-D, wherein each cell contains 16 32-bit words. A separate routing control word (RCW) FIFO 464A-D may be included to hold four data words corresponding to the four RCWs that could be present for the four cells (i.e., assuming each cell contains a unique packet). A separate length FIFO 462A-D may also be included to hold the length of up to four packets that may be present in input FIFO 402. A separate set of 64 flip-flops 470 may be used to hold a 1-bit EOF flag, indicating whether the corresponding input FIFO word is the last word of a packet. A related set of four flip-flops 466A-D, one per cell, may be used to indicate whether an EOF exists anywhere within a cell. Note that the figure merely illustrates one particular embodiment, and that other embodiments are possible and contemplated.

FIG. 6 illustrates one embodiment of a set of pointers that may be used in connection with input FIFO 402 of FIG. 5. Pointers 472A-B point to the head and tail of FIFO 402, respectively. Pointer 474 points to the saved first cell for the currently read packet. Pointer 476 points to the word within the tail cell (as indicated by pointer 472B) that is being written to. Pointer 478 may be used to point to the word within the head cell (as indicated by pointer 472A) that is being read from for store-and-forward routing, while pointer 480 may be used to point to the word within the head cell that is being read from for cut-through routing. As described in greater detail below, cut-through routing forwards a received packet directly to an output port without storing the packet in shared memory 440. In contrast, early forwarding routing places received packets into shared memory 440 until the output port is available (e.g., several clock cycles later).

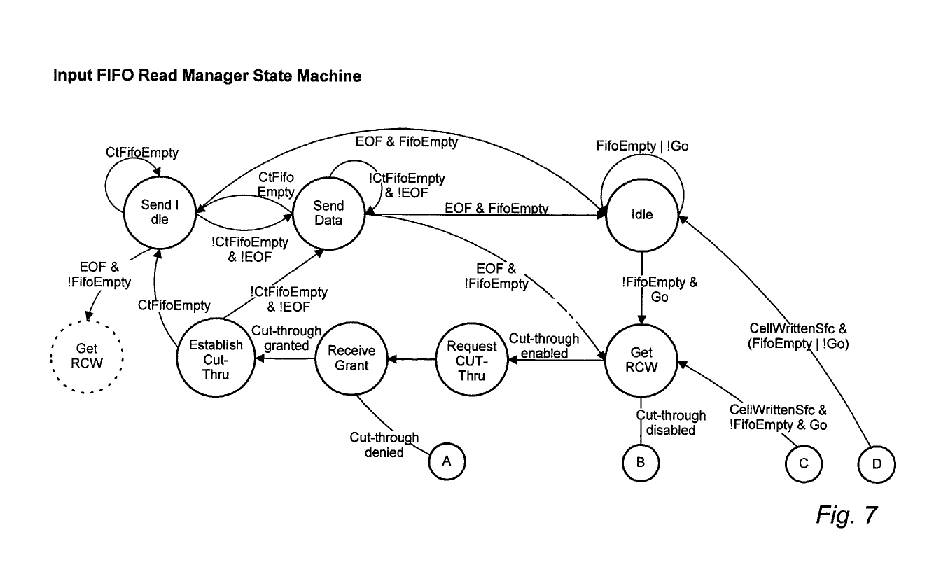

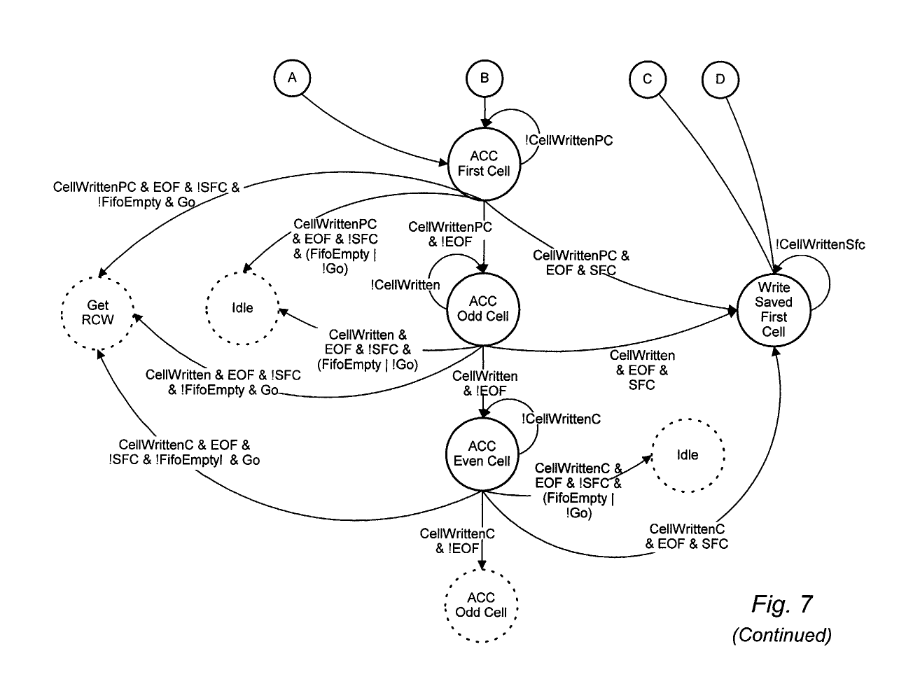

FIG. 7 illustrates one embodiment of a state machine that may be used to operate input FIFO 402 from FIG. 6. In some embodiments, the state machine of FIG. 7 may be implemented in control logic within input block 400. The input block 400 may include an input FIFO controller to manage both reads and writes from input FIFO 402. The controller may control reading of the input FIFO 402, extracting routing information for a packet, establishing cut-through (if possible), and sending the packet to shared memory 440 if cut-through is not possible or granted. Further, in cases where the length of a packet is written into the header, the controller may save the first cell of the packet in input FIFO 402. After reading and storing the rest of the packet, the controller may return to the saved first cell and write it to shared memory 440 with an updated length field. One potential advantage to this method is that it may reduce the processing required at egress. For example, in the case of a packet going from a Fibre Channel port to a Gigabit Ethernet port (i.e., an IP port), normally the packet would be stored in its entirety in the output FIFO so that the length could be determined and the header could be formatted accordingly. However, by saving the first cell in the input FIFO, the length of the packet may be determined once the packet has been completely written to shared memory. The header (in the first cell) may then be updated accordingly, and the first cell may be stored to shared memory. Advantageously, the packet is then ready to be output without undue processing in output block 460.

In one embodiment, the controller (i.e., state machine) may run at either an effective 104 MHz or 52 MHz, based upon whether it is a 1 Gbps or 2 Gbps port (e.g., with an actual clock frequency of 104 MHz). State transitions may occur every-other cycle in the 1 Gbps case, or every cycle in the 2 Gbps case. These are merely examples, however, and other configurations and operating frequencies are also possible and contemplated.

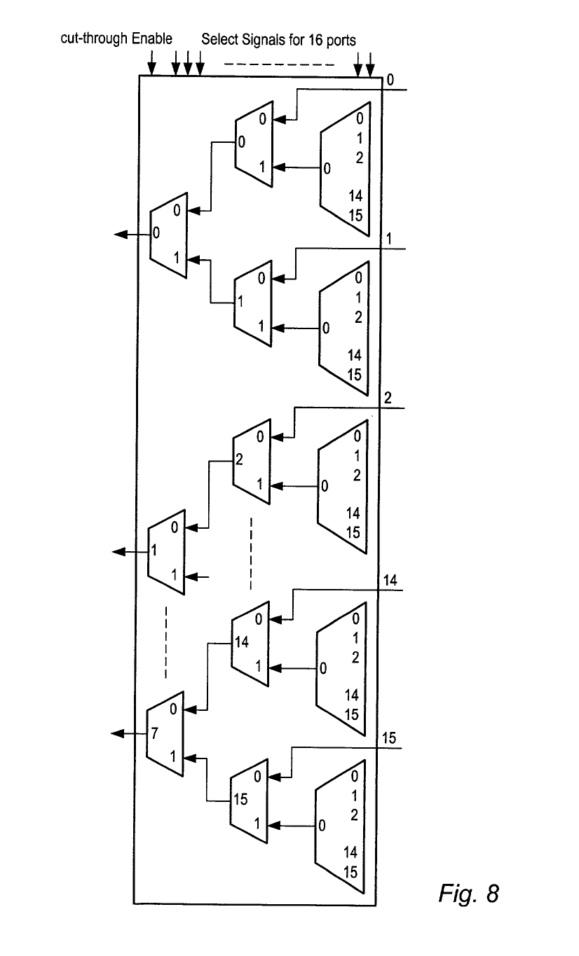

FIG. 8 is a diagram illustrating details of one embodiment of multiplexing logic 428 within data transport block 420. Multiplexing logic 428 selects the data that should be forwarded to the output port (i.e., via output FIFO 462). If early forwarding/store-and-forward routing is used, then multiplexing logic 428 will select the data coming from shared memory 440's read data port queue. If the data to be forwarded is a cut-through packet, multiplexing logic 428 selects the data from cut-through cross bar 426 and sends it to the output port depending on the select signals generated by the control logic. If cut-through routing is disabled, then the data from the shared memory 440 is forwarded. In one embodiment, multiplexing logic 428 is configured to only select the cut-through data for the ports for which cut-through routing is enabled. For all the other ports, the data from shared memory 440's read queues is forwarded.

The first set of multiplexers 620 select the input port data from which it needs to be cut-through depending on the port select signal generated by the cut-through master. Once the correct port data is selected, the next set of multiplexers 622 selects between the cut-through data or the data from the SRAM read queues. The control logic will clear the cut-through select bit once the cut-through forwarding is complete so that the data from shared memory 440 read queues is forwarded as soon as the cut-through is disabled.

To save pin count, in some embodiments two output ports may share one data bus. In this configuration the data from two adjacent ports is multiplexed and sent to the output block. For example, in 1 Gb mode, port N uses the first 104 MHz clock and port N+1 uses the second 104 MHz clock for the data. This means that the effective data-rate per port in 1 Gb mode is 52 MHz. In 2 Gb mode, each cycle contains data for port N, and thus the effective data-rate is 104 MHz. However, other configurations and operating speed are also possible and contemplated.

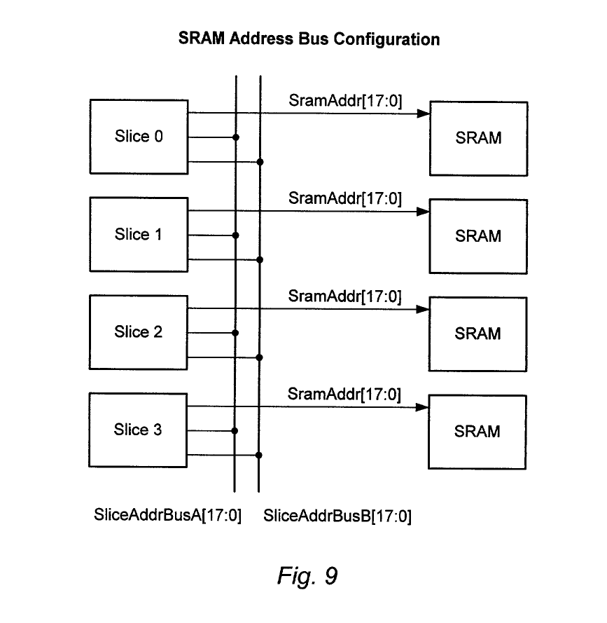

FIG. 9 illustrates details of one type of address bus configuration that may be used with shared memory 440. As shown in the figure, shared memory 440 may be divided into a plurality of blocks 630A-D, wherein each block corresponds to a slice 632A-D (i.e., one portion of input block 400, data transport block, and output block 460). For example, shared memory 440 may be 8 megabytes of SRAM (static random access memory), with each slice 632A-D accessing its own block 630A-D that is 2 MB of external SRAM. Note that shared memory 440 may be implemented using any type of random access memory (RAM) with suitable speed characteristics.

In this embodiment, the interface between the slices 632A-D and the external SRAM blocks 630A-D is a logical 128-bit data bus operating at 104 MHz, but other bus configurations are possible. However, it is possible for any slice to read from another slice's SRAM block; in a four-slice implementation, the full data interface across four slices is 512-bits, with data distributed across all four external SRAM blocks 630A-D. As a result, any given slice needs to address all four SRAM blocks whenever it needs to do an SRAM read or write access. This leads to a number of different possibilities for how the address buses can be arranged between the slices and shared memory 440. Some of these options include using some form of shared global address bus that is time division multiplexed (TDM) between the 16 ports.

In one embodiment, all slices share a single global TDM address bus connected to all SRAM blocks. However, it may be difficult to drive this bus at higher frequencies (e.g., 104 MHz) because the bus would have to span the entire motherboard and have multiple drops on it. In another embodiment, two 52 MHz TDM global address buses are used. Ports 0 and 2 on the slice drive address bus A on positive edges of the 52 MHz clock, and ports 1 and 3 drive address bus B on negative edges of the 52 MHz clock. An external multiplexer may then be used in front of each SRAM block (e.g., selected by a 52 MHz clock and with the two global buses as inputs). The output of the multiplexer is fed to a flip-flop clocked by the 104 MHz clock. With this timing, there are two 104 MHz cycles for the inter-slice address buses to travel and meet the setup timing to the 104 MHz flip-flop. There is one 104 MHz cycle for the output address bus from the multiplexer to meet the setup timing to the SRAM pins. Other configurations and timings are possible and contemplated.

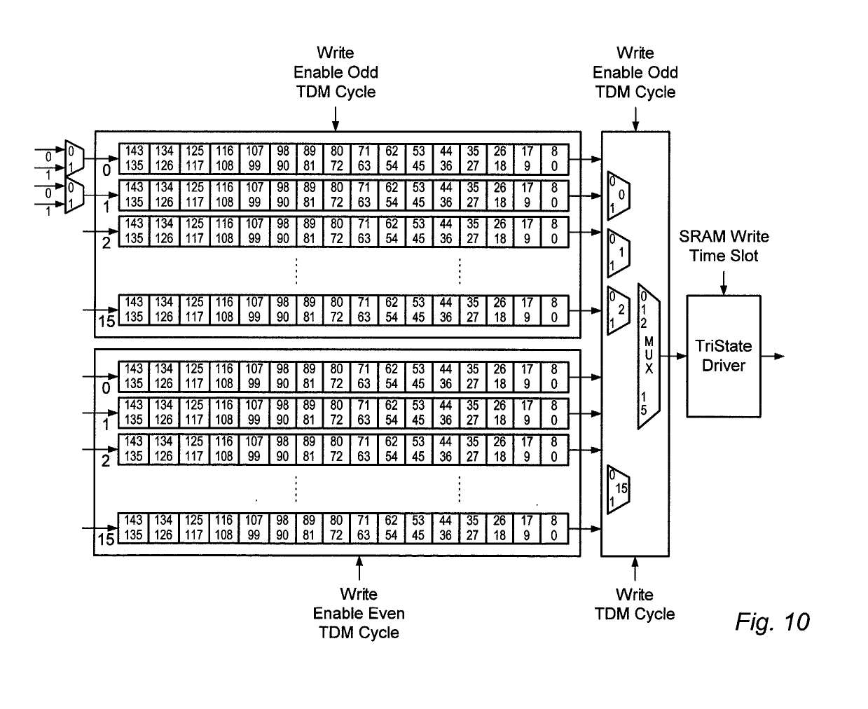

For example, in yet another embodiment, the multiplexer and flip-flop are integrated into data transport block 420 and switch fabric 140. This configuration may use two extra sets of 18 bit address pins on the switch fabric 140 chip to support bringing the two effective 52 MHz shared buses into and out of the chip. A port drives the shared address bus in the TDM slot of the output port that requested the data. In all other slots, it receives the addresses that are sent on the buses and repeats them onto the local SRAM bus. This embodiment is illustrated in FIG. 10. Note that in this embodiment the buses may be clocked at a higher frequency (e.g., 104 MHz), while the data rate (e.g., 52 MHz) is achieved by driving the addresses on the buses for two consecutive cycles.

FIG. 10 illustrates one embodiment of cell assembly queue 422 within data transport block 420. As shown in the figure, assembly queue 422 receives 8 data transport buses coming into the slice and writes the lower 9-bits of the data into the respective SRAM write queue 640. One motivation behind performing cell assembly is to increase bandwidth for embodiments that have wide ports to shared memory 440. However, if cells are used it may be desirable to configure the system to have greater memory bandwidth than the total port bandwidth in order to achieve desirable performance levels. For example, when a packet is received, additional information (e.g., overhead including routing control information and IP header information for Fibre Channel packets) is added to it. A worst-case scenario may occur when the packet is less than 64 bytes long, but the overhead added to the packet causes it to be greater than 64 bytes long (e.g., 66 bytes long). In this situation, a second cell is used for the final 2 bytes of the packet. Thus, to ensure that the switch is not unduly limiting the performance of the network, a 2x speed up in total memory bandwidth compared with total line bandwidth may be desirable.

In one embodiment, it takes a complete TDM cycle to accumulate 144-bits for a single 1 Gbs port (128 bits of data and 16 control bits). After accumulating 144-bits of data, the data is written to shared memory 440 in the port's assigned write timeslot in the next TDM cycle. The data will be written into shared memory 440 in a timeslot within the same TDM cycle. Thus, while writing the accumulated data to shared memory 440 for a particular port, there may be additional input data coming from the port that continues to be accumulated. This is achieved by double buffering the write queues 640. Thus, data from the input ports is written to one side of the queue and the data to be written to shared memory 640 is read from the other side of the queue. Each port's 144-bits of accumulated write data is written to the shared memory in the port's assigned write timeslots. In this embodiment, every port is capable of writing a complete cell in a single TDM cycle.

In 2 Gb mode, 144-bits for a port are accumulated in one-half of a TDM cycle, i.e., in sixteen 104 MHz cycles. Each 2 Gb port has two timeslots, as well as a pair of cell assembly/disassembly queues. Thus, every 16 cycles one of multiplexers 642 in front of the cell assembly queues for ports N and N+1 switches the data from flowing into port N's cell assembly queue to flowing into port N+1's cell assembly queue. In this embodiment, when writing into port N's queue, port N+1's queue is neither write-enabled nor shifted. Similarly, when writing into port N+1's queue, port N's queue is neither write-enabled nor shifted. Each queue remains double-buffered, the same as in the 1 Gb mode. Both queues are written to SRAM, in their assigned timeslots.

Double buffering is achieved by having two separate sets of queues 644A and 644B. At any given time, one set is configured for accumulating the data as it comes from the input block, and the other set is configured to write the accumulated data to shared memory 440. This behavior of the queues 644A-B is changed once every complete TDM cycle. In one embodiment, the queues are implemented as a shift register with 9-bits of data shifting right. In 1 Gb mode, the shifting may occur once every two 104 MHz cycles (once every 52 MHz cycle). In 2 Gb mode, the shifting may occur once every 104 MHz cycles. So after 16 writes, the data in the queue 422 will be as shown in FIG. 10. The queues are followed by two stages of multiplexers 642. The first stage of multiplexers are 2-1 multiplexers which are used to select between the two queues based on which one has accumulated the data and is ready to supply it to shared memory 440. The second stage of multiplexers is used to select between the different ports depending on the port's assigned write timeslot. The final selected 144-bits of data are written to shared memory 440. Tri-state driver 648 is used to tri-state the bus between queue 422 and shared memory 440 when the port is in the read TDM slot.

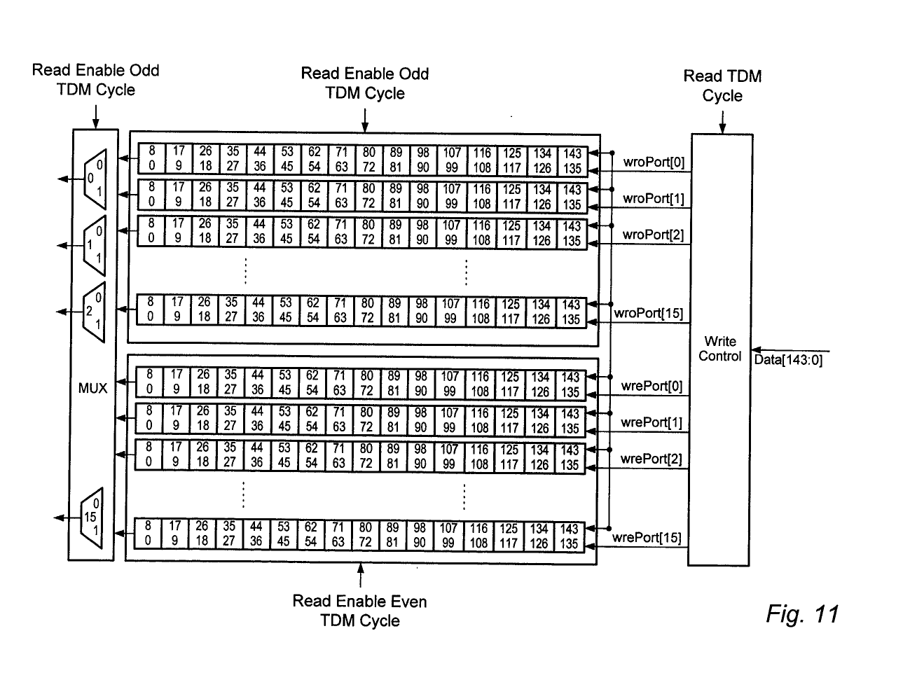

Turning now to FIG. 11, one embodiment of cell disassembly queue 424 is shown. In this embodiment, each port reads 144-bits of data from shared memory 440 in the port's assigned TDM read timeslot. In cut-through forwarding, data transport block 420 is provided with which output ports the packet is being forwarded to, but in the store-and-forward routing mode, data transport block 420 does not have this visibility. Instead, the control logic to read the packet is in input block 400. Input block 400 reads the packet in the output port TDM read timeslot, so the packet is forwarded to the correct output port.

Shared memory 440 write data is written into double-buffered cell disassembly queues 424. Similar to cell assembly queues 422, the data read from shared memory 440 is written to one side of the double-buffered queues while the data sent to the output ports is sent from the other side of the buffer. In one embodiment operating in 1 Gb mode, it may take the entire TDM cycle to read the 16 entries out of the back-buffered cell disassembly queue. In this embodiment, the data is clocked out one word every two 104 MHz cycles from a given queue. Data path multiplexers 665 then switch between the words of adjacent ports to be sent over the inter-slice data path at 104 MHz. In 2 Gb mode, the 16 entries may be read out in one-half of a TDM cycle from the double-buffered cell disassembly queue 424. In this case, data is clocked out one word every 104 MHz cycle. Data path multiplexers 665 then switch between ports N and N+1 every 16 cycles, rather than every cycle, such that contiguous data flows at a data rate of 104 MHz. Note, that the timing given herein is merely for explanatory purposes and is not meant to be limiting. Other operating frequencies are possible and contemplated.

In one embodiment, the data from shared memory 440 is read 144-bits at a time in every read TDM cycle. Based on the read TDM timeslot, the write to the respective port is asserted by the write control logic within queue 424. The write control logic also asserts the corresponding enable signal. In the queues 424, the data order in which the data is sent to the output block is the same order in which the data is received from input block 400. Every cycle, the data sent to output block 460 is from the lower 9-bits of each queue. That means in every other 104 MHz cycle (1 Gb mode), or every 104 MHz cycle (2 Gb mode), the data is shifted to the left so that the next set of data to be sent to output block 460 is in the lower 9-bits of the bus. The output multiplexers 424 select the data from the side of the shared memory that is not writing the data and send the 9-bits to output block 460.

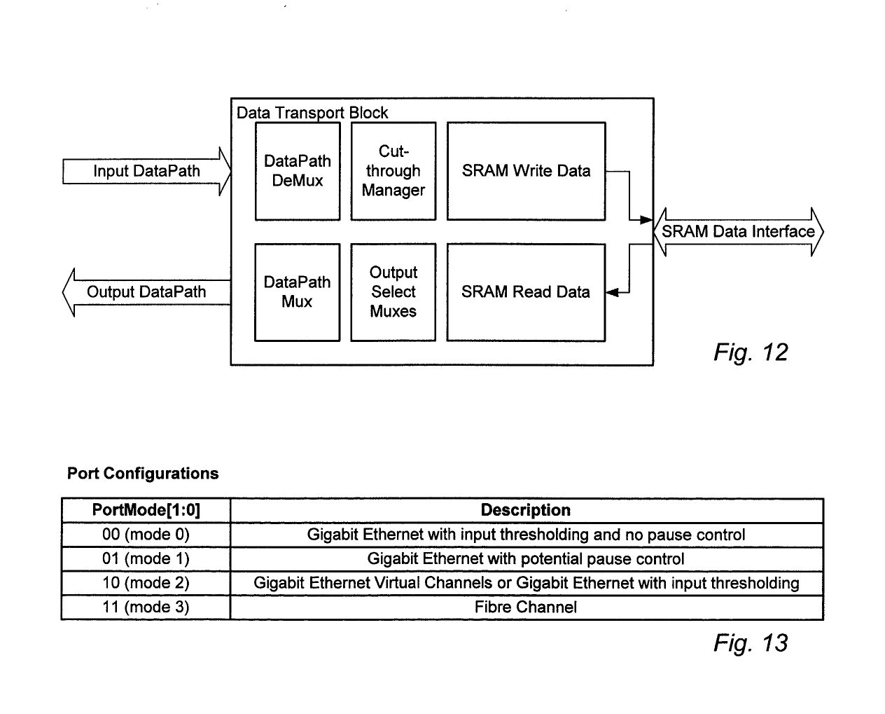

FIG. 12 is a data flow diagram for one embodiment of data transport block 420. Input data path 670 connects data buses (e.g., 10-bits wide) from the input blocks 400 of all slices. The tenth bit communicates a “cut-through” command, while the other nine bits carry data from input blocks 400. The cut-through command may be used to establish a cut-through connection between the input and output blocks. In the case of cut-through, the input data can be sent directly to the output data buses. For early forwarding/store-and-forward routing, the data is sent to the cell-assembly queues 422 and shared memory 440.

In one embodiment, output data path 672 connects to the 9-bit data buses of the output blocks of all slices. These data buses are used to carry data to the output blocks. The output data can be sent directly from the input data buses, in the case of cut-through, or for store-and-forward, be sent from the cell-disassembly queues 424.

In another embodiment, the shared memory data interface 674 may provide a means for storing and retrieving data between the switch fabric 140 and shared memory 440. In this embodiment, the interface is 144-bit wide and includes 128-bits for data and 16 control bits. This results in each 32-bit data word having four control bits. Each data word may have one end of file (EOF) bit and an idle bit. The other two bits may be unused.

In one embodiment, the 144-bit bus is a TDM bus that operates at 104 MHz. In each of the first 16 cycles, 144-bits may be read from shared memory 440 and transferred into one of the cell disassembly queues 424. The 17th cycle is a turnaround cycle when no data is sent or received. Then in each of the second 16 cycles, the 144-bit contents of one of the cell assembly queues 422 are transferred to the SRAM across the bus. The 34th cycle is a turnaround cycle when no data is sent or received. This TDM cycle then repeats.

All of the slices may be synchronized with each other so that they drive the shared memory bus and the inter-slice messaging bus in their respective timeslots. Two signals, SYNC_IN and SYNC_OUT are used to achieve this synchronization. SYNC_IN of data transport block 420 is connected to the SYNC_OUT of input block 400. SYNC_OUT of data transport block 420 is connected to the SYNC_IN of output block 460. As shown in the figure, cut-through manager 676 controls the cut-through select signals sent to the output select multiplexers. Output select multiplexers 678 are the final set of multiplexers to select the correct data to be forwarded to output block 460.

In one embodiment, synchronizing the fabric slices allows all of the slices to be aware of or “know” the current timeslot. In one embodiment, the synchronization of the fabric slices may be performed in the following manner. Each fabric slice may have SYNC_IN and SYNC_OUT pins. Each fabric slice will assert SYNC_OUT during time slice 0. Each fabric slice will synchronize its time slice counter to the SYNC_IN signal, which is asserted during time slice 0. Fabric Slice 0 will have its SYNC_IN signal connected to GND (deasserted). SYNC_OUT may be wired from one slice to SYNC_IN of the neighboring fabric slice. The effect is that all fabric slices generate SYNC_IN and SYNC_OUT simultaneously. For example, if the shared memory has 34 timeslots, the timeslot counter may be a mod-34 counter that counts from 0 to 33. When SYNC_IN is asserted, the counter is loaded with 1 on the next clock cycle. When the counter is 33, SYNC_OUT is asserted on the next clock cycle. In one embodiment, an interrupt may be generated to the CPU if a slice loses synchronization.

Port Modes, Resource Tracking and Packet Dropping

This section describes flow control, resource tracking and the conditions under which packets may be dropped (i.e. not forwarded through an output port) in embodiments of a network switch. A network switch may be comprised of one or more chips or slices, each supporting one or more ports. In one embodiment, a network switch may comprise four slices, each supporting four ports, for a total of 16 ports. Other embodiments with other numbers of slices and ports per slice are possible and contemplated. For example, a 2-slice embodiment with 4 ports per slice is contemplated.

In one embodiment, each port of the network switch may operate in one of a plurality of modes. FIG. 13 illustrates a 2-bit field per port that may be used to define the current operating mode of the port according to one embodiment. In one embodiment, the operating mode of each port in a slice may be stored in one or more programmable registers to allow reconfiguration of the operating modes of the ports. In one embodiment, a slice may support two or more ports concurrently configured to operate in different modes.

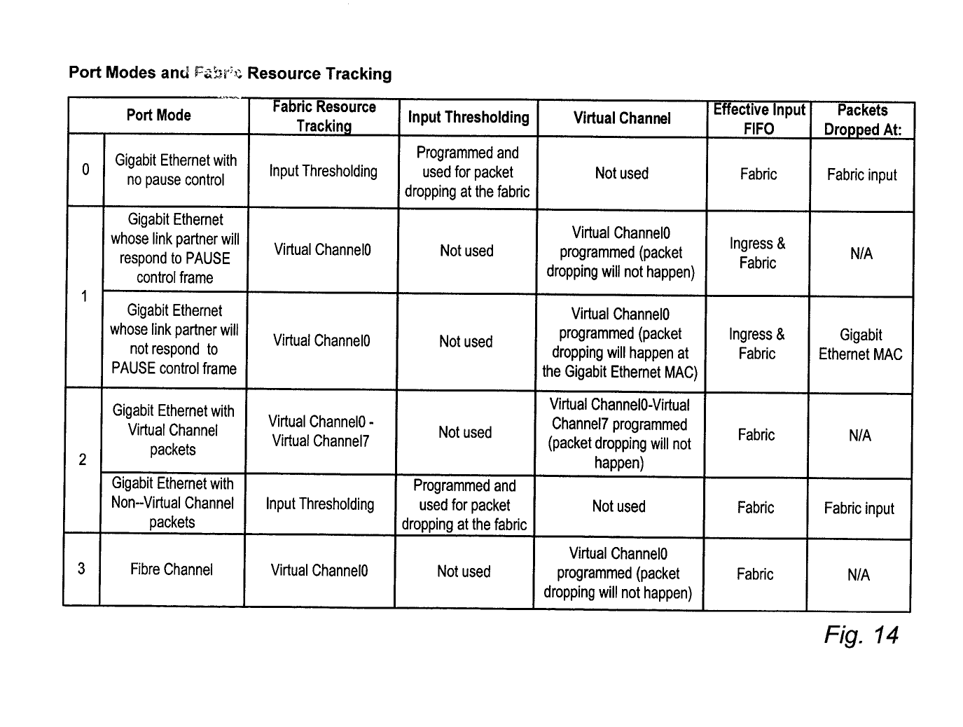

In one embodiment there may be four modes (modes 0 through 3). FIG. 14 is a table summarizing various aspects of the four port modes, resource tracking and the conditions in which packets may be dropped. In this embodiment, in mode 0 a port may be configured as a Gigabit Ethernet port that does not generate pause frames, and where data flow is regulated via input thresholding (see the section on input thresholding below). In mode 1, a port may be configured as a Gigabit Ethernet port that can negotiate generation and reception of pause frames. The network switch (e.g. fabric) monitors internal watermarks and sends resource usage information to the ingress block. The ingress block monitors its own watermarks and, based on its usage and the information it received from the fabric, sends pause control requests to the Gigabit Ethernet MAC (GEMAC) associated with the ingress block. A MAC (Media Access Control) may be generally defined as logic for coupling a port to a data transport mechanism (e.g. Gigabit Ethernet). A GEMAC may be defined as logic on a network switch for coupling one or more ports of the network switch to a Gigabit Ethernet. In one embodiment, a GEMAC may be comprised in the ingress and/or egress blocks. In another embodiment, one or more GEMACs may be between the ingress and egress blocks and the ports associated with the ingress and egress blocks.

Embodiments of the network switch may also support a novel virtual channel mode of Gigabit Ethernet. One embodiment of Gigabit Ethernet virtual channel may use a credit-based flow control method. One embodiment of a network switch may support K virtual channels per port, where K is a positive integer. In one embodiment, K=8. In mode 2, a port may be configured as a Gigabit Ethernet port supporting virtual channels, and data may be regulated via credits. Additionally, in this mode packets that are not associated with virtual channels may be regulated via input thresholding. In mode 3 a port may be configured as a Fibre Channel port, and data flow is regulated via credits.

For port mode 0, the Gigabit Ethernet MAC (GEMAC) does not generate pause frames, and also does not respond to pause frames. As such, no flow control is executed in this mode. Instead, input thresholding is used. In input thresholding, packets entering a slice and assigned to a thresholded group and flow and, when at least one of one or more resources limits used in the input thresholding for the group are reached, at least some of the incoming packets may be dropped.

For port mode 1, the GEMAC may generate pause frames and may respond to pause frames (depending on what was negotiated with the GEMAC's link partner during an auto-negotiation phase). So in this case, flow control may or may not be executed. If pause frames are generated and accepted by the link partner, and if the network switch and the link partner are programmed correctly, packets will never be dropped; otherwise packets may be dropped once resources in the input FIFO are exhausted. In one embodiment, for port mode 1, the effective input FIFO comprises the ingress block's configurable Input FIFO and a programmable amount of space in the shared memory.

Gigabit Ethernet virtual channel (port mode 2) flow control is based on credits. The fabric, along with the ingress block, egress block and the MACs, keep track of what resources are currently in use. The GEMAC provides the appropriate information (e.g. in the form of virtual channel Ready (VCReady) signals or packets) to its link partner. If things are programmed and working correctly, packets will not be dropped. Otherwise, once resources are exhausted, packets may be dropped. Port mode 2 also allows packets on threshold groups, and thus both types of resource tracking may be used in port mode 2.

For port mode 2 (VC packets), the effective input FIFO used to compute the number of credits available may be based on the fabric's shared memory only. However packets transition through the ingress block's Input FIFO before getting to the fabric. Preferably, this is accounted for by the MACs when computing the available credits. A signal (e.g. ib_IgFreePktDescVCX[11:0], where X identifies the virtual channel number) may be used to indicate the number of packet descriptors that are free for every virtual channel on every port. Again the fabric, irrespective of the port mode, preferably drives out these signals to the ingress block, and the signals are used for port mode 2 (virtual channel packets). The ingress block may track how many packets it has in its Input FIFO for each of the virtual channels. Subtracting these numbers from the values supplied from the fabric provides the available packet descriptors for each of the virtual channels. These numbers are then provided to the GEMAC over one or more signals (e.g. ig_GmFreePktDscVcX, where X identifies the virtual channel number). The GEMAC may use these signals to generate VCReady information (see description of VCReady in the section on virtual channels below). If the link partner in these cases doesn't conform to the credit-based flow requirements and sends packets over when it doesn't have a non-zero credit count, then the packets may travel to the fabric and be dropped by the fabric's input block.

In one embodiment, information in terms of resource usage is provided by the fabric (ingress path) and to the fabric (egress path) in a uniform manner, and is somewhat independent of the actual mode of a particular port. The information may be used or ignored in a manner that is appropriate for the mode in which the port is configured.

In one embodiment, a management CPU of the network switch may allocate resources for each of the ports on the slice (e.g. four ports) by programming one or more resource configuration registers. For port mode 0, resource allocation may be tracked through the input thresholding mechanism for groups and flows as described below in the section on input thresholding In one embodiment, port mode 0 packets may be classified with the field GrpVcNim[4:0]=1xxx. For port modes 1 and 3, resource allocation information may be tracked and passed to the various blocks within the slice using virtual channel 0 (VC0) registers and signals. In one embodiment, port mode 1 and 3 packets may be classified with the field GrpVcNim[4:0]=00000). For port mode 2, information may be tracked and passed to the various blocks within the slice using each virtual channel's registers and signals. In one embodiement, K=8. In one embodiment, port mode 3 packets may be classified with the field GrpVcNim[4:0]=00xxx.

In one embodiment, resource usage (both packets and clusters) for each of the virtual channels on each of the ports on the slice may be tracked independently of the port mode. If things are programmed correctly, then this information may only be meaningful for port mode 2 (VC0-VC7) and may be partially meaningful for port mode 1 & 3 (VC0 only). As packets get allocated on a virtual channel, the counts in the appropriate resource usage memories may be incremented. As packets are read out of the shared memory, the usage count may be decremented. In one embodiment, this information may be available at every clock cycle for every virtual channel. There also may be some special signals and registers that are used for mode 1 ports.

In one embodiment, at the slice's input block, software programmable registers may be used to define resource allocation limits for every virtual channel on every port for both clusters and packet descriptors. Again, for port modes 1 and 3, only the VC0 numbers may be meaningful and should be the only ones programmed. For port mode 2, up to K virtual channel numbers may be meaningful depending on how many virtual channels have been negotiated, where K is a positive integer representing the maximum number of virtual channels on a port. In one embodiment, K=8. As packets come into the switch and request allocation of resources, the “in use” numbers from the resource tracking memories may be compared against the allocated limit. The input admission logic may successfully allocate the packet only if the “in use” count is less than the allocated limit. Otherwise, the packet may be dropped.

In one embodiment, for mode 1 ports, if pause control is enabled and working (if the link partner accepted pause control during auto-negotiation) then packet dropping should never happen. If pause control is not enabled or not working properly, then packets may not get dropped in the fabric; however, because of backpressure mechanisms implemented in the ingress path, packets may be dropped in the GEMAC. In one embodiment, for ports using credit-based flows (e.g. mode 2 ports (only virtual channel packets) and mode 3 ports), packet dropping should never occur if all the appropriate control registers are programmed correctly.

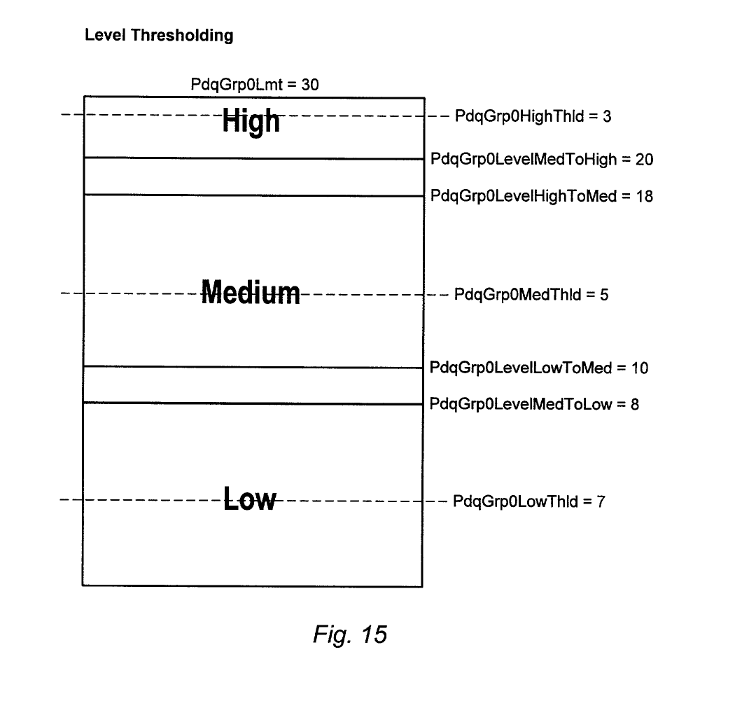

FIGS. 14 and 15 are tables summarizing how resources are tracked in the various port modes. Note that, for ports using flow control (e.g. credit-based or control frame-based flow control), packet dropping should not happen at the fabric if things have been programmed correctly inside the network switch/slice and the link partner(s) are following pause and/or credit-based protocols correctly. If these conditions are not met, then, if resources are not available, the network switch may drop flow-controlled packets. For ports using input 4 thresholding (e.g. port mode 0 and non-virtual channel packets for port mode 2), packet dropping may occur at the fabric if one or more resource limits are reached. In one embodiment, resource tracking for these modes may use registers associated with input thresholding as described below.

As described above, a packet entering a slice of a network switch through a Gigabit Ethernet port may be classified as a packet that is subject to either input thresholding or flow control. In one embodiment, this classification may be achieved through a multi-bit field (e.g. 5 bits), which is used as the virtual channel/threshold group number (e.g. GrpVcNum[4:0]). In this embodiment, one bit (e.g. GrpVcNum[4]) may be used to indicate whether the packet belongs to a (virtual) flow-controlled channel (e.g. GrpVcNum[4]=0), or whether it is subject to input thresholding through assignment to a threshold group (e.g. GrpVcNum[4]=1). A packet is not allowed to belong to both classes. In one embodiment, if the packet is assigned to a virtual channel, the virtual channel number may be designated in the multi-bit field. For example, in one embodiment that supports 8 virtual channels, the lower 4 bits of the multi-bit field may be used to represent the virtual channel number, and the valid values for the lower 4 bits (e.g. GrpVcNum[3:0]) are 0xxx, where xxx may have a value from 0-7 inclusive. In one embodiment, if the packet is subject to input thresholding, the packet may be assigned to a threshold group by a network processor of the network switch. For packets assigned to a threshold group, the multi-bit field may include a threshold group number. In one embodiment where there are 16 threshold groups, the lower 4 bits of the multi-bit field may be used to represent the threshold group number, and the valid values for the lower 4 bits (e.g. GrpVcNum[3:0]) are 0-15 inclusive.

Input Thresholding

A packet entering a slice of a network switch through a Gigabit Ethernet port may be classified as a packet that is subject to input thresholding, for example, if the packet is not subject to flow control. In general, thresholded packets are subject to being dropped at the input port when one or more resource allocation limits are exceeded. Input thresholding may only be applied to IP traffic in the network switch. Storage traffic (e.g. Fibre Channel traffic) in a network switch may not be subject to input thresholding, as it is not desirable to allow storage traffic to be dropped. For IP traffic, one or more higher-level protocols (e.g. TCP) may detect packets dropped by the network switch and resend the dropped packets.

In one embodiment, all packets entering a slice of the network switch that are subject to input thresholding may be assigned to one of N groups and one of M flows of the slice, where N and M are positive integers. In one embodiment, N=16. In one embodiment, M=1024. In one embodiment, the assignment is made in one or more fields of the packet header (e.g. the GrpVcNum and FlowNum fields respectively). In one embodiment, group assignment and/or flow assignment may be performed by a network processor of the network switch.

A definition of “threshold group” as used herein may include the notion of a structure for managing one or more data streams (e.g. a stream of packets) being received on the network switch using thresholding as described herein to control the allocation of resources (e.g. memory portions) to the one or more data streams. In the context of threshold groups, the definition of “flow” as used herein may include the notion of a structure to which incoming packets of the one or more data streams may be assigned to be managed within the threshold group. Thus, a flow within a threshold group may be empty, may include packets from one data stream, or may include packets from multiple data streams. Various parameters used in the implementation of the threshold group and flows of the threshold group may be maintained in hardware and/or software on the network switch.

Resources on the slice (e.g. packet descriptors and clusters) may be allocated among the groups on the slice. Input thresholding may be used to prevent a particular flow within a group from using up all of the resources that have been allocated for that group. In one embodiment, each threshold group may be divided into a plurality of levels or regions of operation. In one embodiment, there are three such levels, and the three levels may be designated as “low”, “medium” and “high”. As resources are allocated and/or freed in the group, the group may dynamically move up or down in the levels of operation. Within each level, one or more different values may be used as level boundaries and resource limits for flows within the group.

In one embodiment, registers may be used to store the various values (e.g. thresholds, maximums, etc.) used in implementing input thresholding. In one embodiment, at least a portion of these registers may be programmable registers to allow the modification of various input thresholding parameters. These registers may be used to control resource allocation and thresholding for the groups within a slice. For each group, a set of these registers may be available for controlling resource usage within the group, for example, packet descriptor resource usage and cluster resource usage. In one embodiment, there is one set (e.g. 8) of registers used for packet descriptors for each group, and one set of registers used for clusters in each group. Thus, in one embodiment, there are 16 total registers for each group and, for an embodiment with 16 groups per slice, a total of 256 registers. These registers may include, but are not limited to:

GrpLimit—This register specifies the maximum number of clusters or packet descriptors that can be allocated for the group.

GrpLevelLowToMed—This register stores the threshold used to determine when to cross from low level to medium level of operation for the group.

GrpLevelMedToHigh—This register stores the threshold used to determine when to cross from medium level to high level of operation for the group.

GrpLevelHighToMed—This register stores the threshold used to determine when to cross from high level to medium level of operation for the group.

GrpLevelMedToLow—This register stores the threshold used to determine when to cross from medium level to low level of operation for the group.

GrpLowMax—This register determines the value used to limit resource usage of flows for a particular group when the group is in the low level of operation.

GrpMedMax—This register determines the value used to limit resource usage of flows for a particular group when the group is in the medium level of operation.

GrpHighMax—This register determines the value used to limit resource usage of flows for a particular group when the group is in the high level of operation.

In addition to the registers listed above, there may be another register on the slice that applies collectively to all the groups. Again there may be two of these registers, one for packet descriptors and one for clusters:

TotGrpLmt—This register specifies the maximum number of resources (e.g. packet descriptors or clusters) that can be allocated to all the groups on the slice. In one embodiment, this register may be programmed with a value that is less than or equal to the sum of all the GrpLimit registers for all the different groups on the slice. This register may be used in allowing high priority packets in an input thresholding embodiment.

FIG. 15 illustrates one embodiment of input thresholding for a group (group 0, in this example) using multiple levels (e.g. 3 levels) to control resource allocation, and also illustrates exemplary values that may be used for controlling packet descriptor resource allocation using input thresholding. Even though FIG. 15 illustrates thresholding for packet descriptors, the same figure may be referred to in reference to clusters, as the input thresholding schemes are substantially similar for clusters and packet descriptors.

The following is an example of input thresholding using the exemplary values given above for clusters. Group 0 is initially in the low level of operation. A first packet comes into the slice and is assigned to group 0 and flow 0. The first packet uses six clusters. The group remains in the low level of operation. A second packet subsequently comes into the slice and is also assigned to group 0, flow 0. The second packet uses one cluster. Flow 0 is now using a total of seven clusters. The next packet that comes in and assigned to group 0, flow 0 is dropped because the group's current maximum number of clusters that may be used by a flow (as given by the register ClmGrp0LowMax) is seven, and seven clusters are currently in use by flows in the group. A third packet that uses four clusters comes into the slice and is assigned to group 0, flow 1. The third packet is admitted because flow 1's cluster usage is below the current maximum (7). However, now the group moves to the medium level of operation, because 11 total clusters are in use by flows in the group (7 by flow 0 and 4 by flow 1). The low to medium level crossing happens when the number of clusters in use by all flows in the group is greater than the threshold level in the ClmGrp0LevelLowToMed register (initialized to 10 in this example).

Now in the medium level of operation, the group's new maximum number of clusters that can be used by a flow is 5 (determined by the ClmGrp0MedMax register). A fourth packet now comes into the slice and is assigned to group 0, flow 1. This packet is allowed to allocate one cluster, since four clusters have already been allocated for flow 1 and the maximum allowed is 5. Subsequent cluster requests for group 0, flow 1 packets will be denied (unless cluster resources are freed prior to the subsequent cluster requests). Packets that come into the slice and assigned to flows other than 0 and 1 in group 0 will be allowed to use up to five clusters each, but may be denied the clusters if allocating resources to them will exceed resource limits for the flow to which they are assigned. Once the group moves from the medium to the high level of operation, the new maximum number of clusters allowed per flow will be 3 (determined by the ClmGrp0HighMax register). The medium to high level crossing will happen when the number of clusters in use by the group is greater than the threshold level of the ClmGrp0LevelMedToHigh register (initialized to 20 in this example). Packets denied clusters may be dropped from the network switch.

If new packets continue to be allocated to flows in group 0, cluster usage may increase for the group until it approaches or reaches the maximum cluster usage allowed for the group (e.g. ClmGrp0Lmt, initialized to 30 in this example). Packets assigned to flows in the group will not be allocated clusters, and thus may be dropped, if the allocation would cause the group usage to exceed this maximum.

Input thresholding for packet descriptor resource allocation in a group may be handled similarly to cluster input thresholding as described in the above example. Note, however, that each packet assigned to a group and flow uses only one packet descriptor.

As packets assigned to a group are read out of packet memory, allocated resources (including packet descriptor and cluster resources) in the group may be freed. When the resources are freed, the group may move down from the high to medium and subsequently to low levels of operation. In one embodiment, hysteresis may be used at level crossings by overlapping the upper thresholds of lower levels with the lower thresholds of higher levels (shown by the non-shaded portions in FIG. 15). The hysteresis may help prevent the group from bouncing in and out of the different levels of operation as resources are dynamically allocated and freed. For example, the high to medium level crossing will happen when the number of clusters in use by the group drops to less than the threshold level of the ClmGrp0LevelHighToMed register (initialized to 18 in this example), but the group will not cross back into the high level of operation until the number of clusters in use by the group rises above the threshold level in the ClmGrp0LevelMedToHigh register (initialized to 20 in this example.

Resource Tracking

In one embodiment, a slice in the network switch tracks resources (e.g. packet descriptors and clusters) that are being used for packets admitted to the slice. In one embodiment, for input thresholding, counts are maintained within the slice for the number of packet descriptors and clusters that are in use by the following:

Threshold groups for each one of the N groups.

Flows for each one of the M flows within each of the N groups.

Total number of resources in use by all the N groups as a whole.

As packet descriptors and clusters are successfully allocated for incoming packets, these counts may be incremented. When the packet is read out of packet memory or discarded, these counts may be decremented. Packet descriptor counts may be decremented by 1 when a packet is read out and cluster count may be decremented by the number of clusters that were in use by the packet, which is a function of the size of the stored packet.

When a non-high priority packet comes in to the slice and is assigned to a group and flow, the input thresholding admission logic may check to see if enough resources are available for the packet. The logic may look at the resources allocated and the resources currently in use for the particular group and flow to which the incoming packet is assigned. The packet may be dropped if not enough resources are available. In one embodiment, the input thresholding admission logic may include two components—one for packet descriptors and another for clusters. For the packet to be admitted, successful allocation signals must be asserted by both components of the logic to assure there are enough resources for the packet descriptor and one or more clusters required by the packet. Packets generally may include one packet descriptor and one or more clusters. The following describes some conditions under which these allocation signals are asserted.

Packets that enter the network switch on a virtual channel (for example, if GrpVcNum[4]=0) are subject to credit based flow control and are thus not subject to input thresholding. If the flow control registers associated with a virtual channel are set up properly and the link partners follow the prescribed credit based behavior, these packets will always have resources available for them. Hence these packets may never be dropped. However if things are not configured correctly, these packets may be dropped as defined below.

In one embodiment that supports virtual channels, there are K virtual channels available per port. In one embodiment, K=8. In one embodiment, the slice keeps track of the resources (e.g. packets and clusters) in use by every virtual channel on every port of the slice. Resources may be allocated to every virtual channel on every port using programmable registers. When a packet comes into the slice, the packet admission logic may check to see whether the resources in use by the virtual channel to which the packet belongs are less than the allocated limits. Both packet descriptors and clusters may be checked. If either of these checks fail, the packet may be dropped. The packet may also be dropped if either a packet descriptor or a cluster is not available. Early Forwarding may be allowed for virtual channel packets if the total available resources for the virtual channel on the port are greater than or equal to a programmable value (e.g. ClmMinFreeClustersEarlyFwdVC_x_Port_y, where x is the virtual channel number and y is the port number). Every virtual channel on every port may have a different packet size negotiated with its link partner. Hence, in one embodiment, there are individual registers for each virtual channel on each port.

Virtual Channels

Embodiments of network switches as described herein may be incorporated into a Storage Area Network (SAN) that comprises multiple data transport mechanisms and thus must support multiple data transport protocols. These protocols may include, but are not limited to, SCSI, Fibre Channel, Ethernet and Gigabit Ethernet. Because storage format frames (e.g. Fibre Channel) may not be directly compatible with an Ethernet transport mechanism, including Gigabit Ethernet, as they are with the storage transport mechanism, the transmission of storage packets on an Ethernet such as Gigabit Ethernet may require that a storage frame be encapsulated in an Ethernet-compatible frame. In general, an Internet Protocol (IP) frame encapsulating a storage frame may be referred to as a “storage packet.” Note that non-storage packets may be referred to herein simply as “IP packets.”

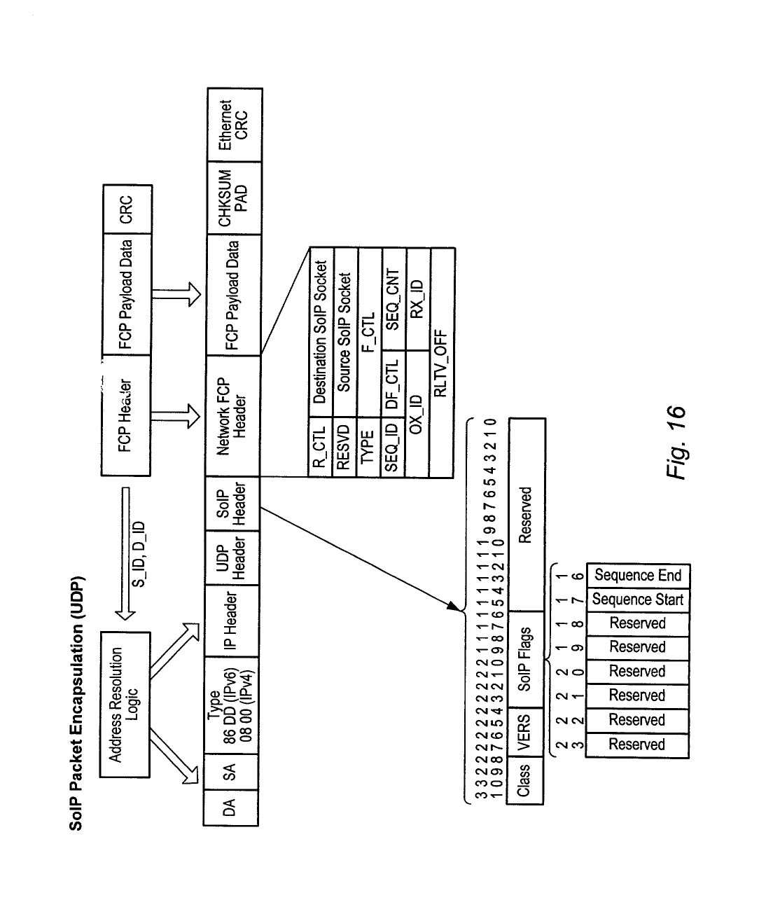

One embodiment of a storage packet protocol that may be used for Gigabit Ethernet is Storage over Internet Protocol (SoIP). Other storage packet protocols are possible and contemplated. An exemplary SoIP packet format is illustrated in FIG. 16. Thus, some embodiments of network switches as described herein support sending and receiving storage packets such as SoIP packets. Storage over Internet Protocol is further described in the U.S. patent application titled “METHOD AND APPARATUS FOR TRANSFERRING DATA BETWEEN IP NETWORK DEVICES AND SCSI AND FIBRE CHANNEL DEVICES OVER AN IP NETWORK” by Latif, et al, that was previously incorporated by reference in its entirety.

FIG. 16 illustrates Fibre Channel (FCP) packet encapsulation in an IP frame carried over an Ethernet according to one embodiment. In FIG. 16, the User Datagram Protocol (UDP) is used for the IP packet. Other protocols, such as TCP, may also be used. Field definitions for FIG. 16 include the following:

DA: Ethernet destination address (6 bytes).

SA: Ethernet source address (6 Bytes).

TYPE: The Ethernet packet type (Ethertype)

FRAME PAD: Any bytes necessary to meet the minimum Ethernet packet size of 64 bytes. The minimum packet size is measured from DA to CRC inclusive.

CHECKSUM PAD: An optional 2-byte field which may be used to guarantee that the UDP checksum is correct even when a data frame begins transmission before all of the contents are known. In one embodiment, a bit or bits (e.g. the CHECKSUM PAD bit in the SoIP header) indicates whether this field is present.

ETHERNET CRC: Cyclic Redundancy Checksum (e.g. 4 bytes).

Embodiments of a network switch are described herein that implement credit-based flow control for Gigabit Ethernet packets and SoIP packets on virtual channels over inter-switch Gigabit Ethernet links. The credit-based flow control method, when implemented on an embodiment of a network switch, may be used in supporting egress (outgoing) packet flows and ingress (incoming) packet flows on one or more virtual channels of the network switch. A packet is a unit of data that is routed between an origin and a destination on the Internet or any other packet-switched network. In general, the terms “packet flow” and “flow” as used herein include the notion of a stream of one or more packets sent from an origin to a destination or, in the case of multicast, to multiple destinations.

In addition to standard Gigabit Ethernet IP packet flow (with and without pause-based flow control) up to K virtual channel based packet flows may be supported on a single Gigabit Ethernet link. In one embodiment, K=8. Note that virtual channels and credit-based flow control of virtual channels as described herein may be applied to other network implementations such as Ethernet and Asynchronous Transfer Mode (ATM). For example, embodiments of network switches may support virtual channels using credit-based flow control for Ethernet packets including Ethernet IP packets and storage packets on inter-switch Ethernet links.

In one embodiment, both IP and storage packets may be transported over the same link. In one embodiment, storage packets are sent over virtual channels on the link, and IP packets are sent on the link but not in a virtual channel. A method is described for marking packets (e.g. Gigabit Ethernet packets) to distinguish between packets subject to credit-based flow control and standard IP packets not subject to credit-based flow control. The transmitting switch may mark each packet using this method, and thus the receiving switch can distinguish between the different packet types. Marking of packets may also be used to distinguish packets that are subject to being sent over one of the virtual channels.

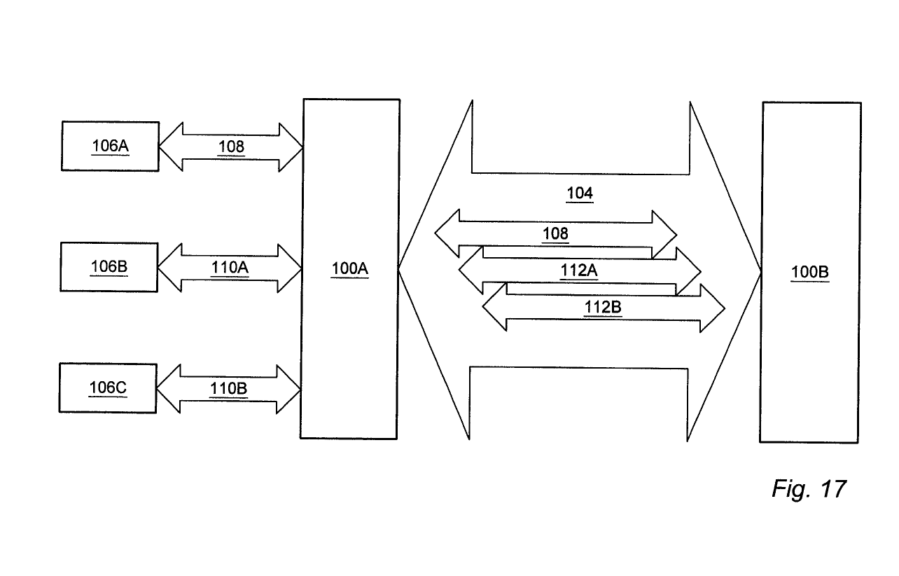

FIG. 17 is a block diagram illustrating two network switches 100A and 100B that both support Gigabit Ethernet virtual channels over Gigabit Ethernet link 104. The figure shows three devices 106A-106C connected to one or more ports on switch 100A. When link 104 is initialized, network switches 100A and 100B may negotiate to determine if both switches can and will support virtual channels over the link 104, the number of virtual channels that will be allowed, and, if the virtual channels are using credit-based flow control, the credit limit for each of the virtual channels (which may be in the egress, ingress, or both egress and ingress directions on each of the switches 100). Other aspects of the link 100 may also be negotiated, such as packet size limits for each of the virtual channels.

After the link 100 is established, device 106A sends Gigabit Ethernet packet flow 108 to switch 100A through an ingress Gigabit Ethernet port of switch 100A. Devices 106B and 106C send Fibre Channel packet flows 110A and 110B to switch 100A through one or more ingress Fibre Channel ports of switch 100A. Fibre Channel packets may arrive on switch 100A in flows 110A and 110B. On switch 100A, each Fibre Channel packet may be encapsulated in a storage (e.g. SoIP) packet and then forwarded to an egress Gigabit Ethernet port for sending to one or more devices via switch 100B. Also, IP packets arriving in flow 108 may be forwarded to the egress Gigabit Ethernet port. Each incoming Fibre Channel packet flow may have been assigned a separate virtual channel 112 on Gigabit Ethernet link 104 during initialization of the flow. Thus, Fibre Channel packets that enter the switch 100A on Fibre Channel packet flow 110A may be encapsulated in SoIP packets and sent to switch 100B on virtual channel 112A. IP packets received on flow 108 may also be sent to switch 100B on Gigabit Ethernet link 104. The flow of packets through virtual channels on Gigabit Ethernet link 104 also works for SoIP packets sent from switch 100B to switch 100A. On switch 100A, the embedded Fibre Channel packets are extracted from the SoIP packets and each sent to its destination device(s). In one embodiment, the flow of packets through the virtual channels on Gigabit Ethernet link 104 is regulated using credit-based flow control.

In one embodiment, credit-based flow control is applied to each active virtual channel separately, and separate credit count information is kept for each virtual channel. Thus, up to K separate “conversations” may be simultaneously occurring on one link, with one conversation on each virtual channel, and with K different sets of resources being tracked for each virtual channel's credit-based flow control. Thus, for the K virtual channels on a port, there is no “head of line” blocking. Preferably, a virtual channel cannot block any of the other virtual channels. In one embodiment, the scheduler on the switch 100 may determine if a particular virtual channel currently lacks credits, and, if so, may move to a second virtual channel with credits to service the second channel.

When a link is established on a switch 100 (separately in the egress and ingress directions), the number of virtual channels that the link will support and the maximum packet size in bytes that may be transferred on the virtual channels of the link, are determined. Having established this, the number of credits (in multiples of packet size where there is one packet per credit) that will be supported on the link in the ingress direction is determined (which corresponds to the egress direction for the switch on the opposite end of the link). Note that it is not required that virtual channels exist in both ingress and egress directions on a link.

The network switch allocates clusters and packets to the active virtual channels on the link. If standard Gigabit Ethernet packet flow is also expected on the link, then the network switch may also allocate clusters and packets to threshold groups for input thresholding the incoming IP packets. Incoming packets may be assigned to one of the active virtual channels by the transmitting port, or the packets may be assigned to a threshold group and have a flow number assigned to them by the network processor of the receiving port, depending on the type of packet (e.g. storage packet or IP packet).

In one embodiment, if an incoming packet attempts to allocate resources for a virtual channel and no resources are available, the packet may be dropped. This is because the fabric and ingress FIFO are preferably not stalled due to one full virtual channel; the other virtual channels preferably continue to be serviced. In one embodiment, the dropping mechanism may be identical to that used for packets using input thresholding. However, given that credit-based flow control is used for the virtual channel mode, dropping preferably never occurs and would be an error condition if it did occur. Such an error condition may arise because of a programming error (for example, credit calculation and internal configuration register setup by the management CPU was incorrect and the network switch ran out of resources) or because of a hard fault somewhere within the network switch logic.

Some requirements for allowing virtual channel credit-based packet flow include, but are not limited to:

The physical links on which it is possible to do flow control per virtual channel exists between two network switches.

Both switches need to agree to do flow control per virtual channel. If they do not then the link will operate as a regular Gigabit Ethernet port.

Both switches have to agree on the same number of virtual channels that they want to support on the physical link. Note that the number of virtual channels supported in each direction on a switch may be different, but the two ends of the physical link (egress on one end and ingress on the other end) must support the same number of virtual channels.

Both switches have to agree on the maximum packet size that they want to support on the link. Note that transmit (egress) and receive (ingress) packet sizes on a link supporting virtual channels in both directions may be different, but both switches have to agree on the sizes.

A number of restrictions may apply to ports on which virtual channels have been established:

Preferably, no standard Gigabit Ethernet pause control is enabled on the link that has virtual channels. Note that, since virtual channels may be established in either direction on a physical link, in one embodiment it is possible to have pause control in the direction in which there are no virtual channels established.

In one embodiment, there is no cut-through operation in the fabric for a link that has virtual channels.

Packet Flow on Virtual Channels

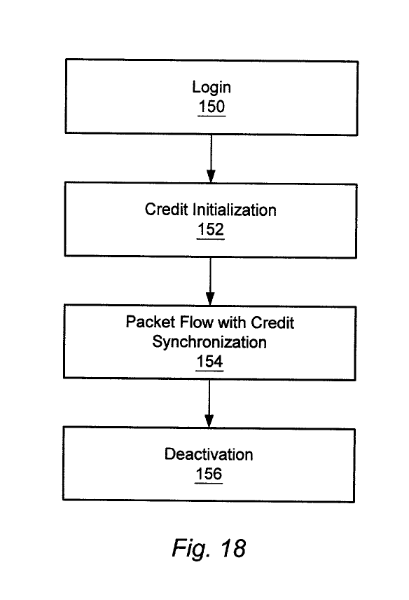

FIG. 18 illustrates one embodiment of a method for establishing, maintaining and deactivating, if necessary, credit-based flow control on virtual channels in a network switch. As indicated at 150, the network switch may first go through a login procedure to determine if virtual channels may be established. In one embodiment, on power-up of the network switch, a port of the network switch (e.g. a Gigabit Ethernet-capable port) may attempt to establish if a corresponding port on another switch is virtual channel capable. In one embodiment, this may be performed by the management CPU of the network switch. In one embodiment, the initiating port is the receiver port and the corresponding other port is the transmitter port. First, the network switch may set up the port as a standard Gigabit Ethernet port (with or without flow control). Then, a number of virtual channel parameters may be set in configuration registers, and the Gigabit Ethernet MAC may be enabled on the port to try and establish contact with the switch on the other end for virtual channel based packet flow. In one embodiment, this may be done by sending a login frame to the port on the other switch. One of several results may happen:

The port on the other side is on a virtual channel-capable switch and it is interested in establishing virtual channels on the link.

The port on the other side is on a virtual channel-capable switch and it is not interested in establishing virtual channels on the link.

The switch on the other side is not on a virtual channel-capable switch and it will not respond to the login frame.

During the login procedure, the port receives standard Gigabit Ethernet packets and as such reverts to the pre-configured standard Gigabit Ethernet mode.

If the login procedure establishes that the switch is a virtual channel-capable switch and is interested in establishing virtual channels on the link, then a credit initialization procedure may be performed as indicated at 152. The management CPU may attempt to establish the number of credits that it wants to give the other port via a credit initialization frame. If this is successful, then the port is configured for virtual channel based packet flow and credit-based packet flow with credit synchronization is started as indicated at 154 of FIG. 18.

As virtual channel tagged packets flow into a switch, credits get used up. Once these packets leave the switch, the credits become available for further packet flow into the switch. This information, which may be referred to as virtual channel readys (VCRDYs), may be transferred to the transmitting port via virtual channel ready frames. This may be done either via special frames sent to the transmitter or by the information being piggybacked onto existing frames going to the transmitter. VCRDYs may perform a similar function for virtual channels that RRDYs perform in Fibre Channel.

It is possible that finite bit error rates may sometimes produce unreliable communication links. On an unreliable communication link, frames carrying information about VCRDYs may be corrupted, and as such the VCRDY information may be effectively “lost”. In one embodiment, to recover lost VCRDYs (and as such credit) a credit synchronization scheme may be used using credit synchronization frames. Under certain error conditions the switch may decide to deactivate the virtual channel mode as indicated at 156 of FIG. 18. In one embodiment, this is done by sending a Deactivation frame.

The following describes one embodiment of a login procedure that may be used for two network switches to agree to do per virtual channel flow control. In one embodiment, a management CPU and/or management software on one or both of the network switches may perform at least a portion of the login procedure. After power-up, a first network switch, if so enabled, may send a login message on a Gigabit Ethernet link using a special MAC Control frame that may be referred to as a login frame. This message may be sent multiple times (e.g. 3 times) with a programmed delay value between each transmission. This login message may include information including, but not limited to:

General information about the type and structure of the switch. This information may be used by the network management software to provide information to the user about the type of network switch that is connected to a particular port. In one embodiment, this information may alternatively be transmitted as part of the auto-negotiation process.

The desired egress packet size (DsrdEgPktSz) for each of the desired virtual channels.

In one embodiment, this may be expressed in bytes.

The supported ingress packet size (SptdIgPktSz) for each of the supported virtual channels. In one embodiment, this may be expressed in bytes.

The desired number of egress virtual channels (DsrdEgVC)

The supported number of ingress virtual channels (SptdIgVC)

On receiving the login message, a second network switch, if so enabled may send a login acknowledgement message back to the original switch via a special MAC Control frame, which may be referred to as a login acknowledgement frame. In one embodiment, the login message may be passed to the management CPU of the second network switch, which may then send the login acknowledgement message back to the original switch. The first switch keeps track of how many login messages it has sent and how many login acknowledgements it has received back. In one embodiment, when the first switch receives the login acknowledgement message, it passes the frame to the management CPU, which keeps track of how many login messages have been sent and how many login acknowledgements have been received. After sending and receiving an appropriate number of login messages and login acknowledgement messages, the first network switch decides whether it will enable the port for virtual channel packet flow.

Each network switch on a particular link may calculate the egress and ingress packet sizes for each of the virtual channels, and the number of egress and ingress virtual channels. These calculations may be based on the information the first network switch sent out in the login message and the information the first network switch received from the second network switch in the second switch's login message. In these calculations, the network switch determines the number of virtual channels it has to support for the other switch (IgVC) and the corresponding size of the packets it will receive from the other switch for each virtual channel (IgPktSz). IgPktSz represents the generic value for the packet size for a particular virtual channel. In these calculations, the switch also determines the number of virtual channels that the other switch will support for it (EgVC) and the corresponding size of the packets that it can send to the other switch (EgPktSz). Note that the packet size that the switches agree upon for each virtual channel is the maximum packet size that can be sent across the link for that particular virtual channel. The maximum packet size may be different on different channels.

The following example illustrates these calculations, which in one embodiment may be done by the management CPU of a particular network switch, or alternatively may be done in each network switch. The letters A and B signify the two switches, and “0” signifies virtual channel zero. The calculations are shown as they take place at switch A:

Ingress packet size for virtual channel 0 (IgPktSz0)=minimum (DsrdEgPktSzB0, SptdIgPktSzA0)

Egress packet size for virtual channel 0 (EgPktSz0)=minimum (DsrdEgPktSzA0, SptdIgPktSzB0)

Ingress VCs (IgVC)=minimum (DsrdEgVCB, SptdIgVCA)

Egress VCs (EgVC)=minimum (DsrdEgVCA, SptdIgVCB)

where:

DsrdEgPktSzA0 is the desired egress packet size that network switch A wants to send to switch B for virtual channel zero;

DsrdEgPktSzB0 is the desired egress packet size that network switch B wants to send to switch A for virtual channel zero;

SptdIgPktSzA0 is the supported ingress packet size for network switch A, channel zero;

SptdIgPktSzB0 is the supported ingress packet size for network switch B, channel zero;

DsrdEgVCA is the desired number of egress virtual channels for network switch A;

DsrdEgVCB is the desired number of egress virtual channels for network switch B;

SptdIgVCA is the supported number of ingress virtual channels for network switch A; and

SptdIgVCB is the supported number of ingress virtual channels for network switch B.

Since flow control (per virtual channel) is based on the concept of credits, once a pair of network switches have gone through the login procedure, a packet size may be agreed upon between the switches so the switches may compute and give “packet-size” credits to each other. At this stage, each switch may have previously calculated, as described above, the number of virtual channels (IgVC) that need to be supported on the ingress side (i.e., for the other switch) and the packet size for each virtual channel (IgPktSz). Each network switch may also track how many resources it has, and how it wants to distribute these resources among the various ports and the virtual channels on each port. Based on all this information, each switch may determine the number of credits it wants to reserve for each virtual channel on the port. In one embodiment, one credit represents one packet of IgPktSz bytes. Having determined the number of credits to be reserved, the network switch may convey to the other switch the credits that are being reserved for each virtual channel on the link. In one embodiment, these calculations may be performed by the management CPU on each network switch.

In one embodiment, in order to transfer credit information between switches the following credit initialization procedure may be performed. In one embodiment a management CPU and/or management software on one or both of the network switches may perform at least a portion of the credit initialization procedure. A credit initialization message may be sent from the first switch to the second switch using a special MAC Control frame, which may be referred to as a credit initialization frame. This message may be sent multiple times with a programmed delay value between each transmission. In one embodiment, the credit initialization message may include information on the number of credits allocated for each virtual channel on the link.

On a network switch, there may be a maximum number C of credits that can be allocated to a link. This maximum number can be encoded in B bits. In one embodiment, C=1024. In this embodiment, C can be encoded in 12 bits. For these values, in an embodiment that supports 8 virtual channels per port/link, there are eight 12-bit values encoded in the credit initialization message. The first n values (where n=IgVC) may have non-zero values. These are the credits for virtual channel numbers 0 through virtual channel number IgVC−1. The last m values (m=8−IgVC) indicate zero credits for unsupported virtual channels. Note that the credit initialization message comes into the switch on the port's ingress path, but it includes information on the credit values for the port's egress path (and the originating switch's ingress path).

On receiving the credit initialization message, the receiving switch may send a credit initialization acknowledgement message back to the original switch via a special MAC Control frame. In one embodiment, the receiving switch may pass the credit initialization message to the management CPU, which then may send the credit initialization acknowledgement message back to the original switch. The original switch keeps track of how many credit initialization messages it has sent and how many acknowledgements it has received back. In one embodiment, when the original switch receives the credit initialization acknowledgement message, it passes it to the management CPU, which keeps track of how many credit initialization messages have been sent and how many credit initialization acknowledgements have been received. After sending and receiving the appropriate number of credit initialization and credit initialization acknowledgement messages, the original switch decides on the number of credits that have been allocated to it by the other switch. The network switch may now have all the information needed to configure the link for virtual channel packet transfer.

Once the login and credit initialization processes have completed, packets may start flowing on the link. For each virtual channel being supported in the egress direction, there may be a register (EgCreditCount) that may be used to keep track of the current state of the outstanding credits on that port. Similarly, for each virtual channel being supported in the ingress direction, there may be a register (IgCreditCount) that may be used to keep track of the current state of the outstanding credits on that port. The EgCreditCount and the IgCreditCount registers may be initialized to the appropriate credit values that have been allotted to them as specified in the credit initialization message. These two values may be different depending on what was negotiated in each direction. However, in one embodiment, the EgCreditCount on a port's egress path and the corresponding IgCreditCount on the far end at the port's ingress path have to be the same value.

When a packet flows out in the egress direction on a particular virtual channel, the appropriate EgCreditCount register may be decremented by 1 (see Rule 1 below). In one embodiment, MAC Control Frames are not counted. When a virtual channel ready message is received, the values in the message may be used to update the EgCreditCount register values (see Rule 2 below). The calculation is shown below for virtual channel 0. Using the VCR subscript identifies the values that are used from the virtual channel ready message:

EgCreditCount[0]=EgCreditCount[0]+VCReady[0]_{VCR}

When a packet is received on a particular virtual channel, the appropriate IgCreditCount register may be decremented by 1 (see Rule 3 below). In one embodiment, MAC Control Frames are not counted. When a virtual channel ready message is sent, the values in the message may be used to update the appropriate IGCreditCount registers (see Rule 4 below). The IgCreditCount register that is updated is the register that belongs to the port and the virtual channel on which the packet arrived. In one embodiment, the Input block of the fabric, along with the ingress block, may keep track of this information.

If the value of an EgCreditCount register for a particular virtual channel reaches 0, packet transmission on that virtual channel may be stopped (see Rule 5 below). Packet transmission on that virtual channel may be restarted once the register value becomes larger than 0—this is a basic premise of credit-based flow control (see Rule 6 below).

Virtual Channel Ready

In one embodiment, virtual channel ready signals or messages may be used to indicate that the receiver has emptied one or more receiver buffers for a particular virtual channel and is ready to receive another packet, i.e., the credit is available for reuse. In the network switch, this means that the buffer is effectively available in the fabric. Mechanisms that may be used to transfer virtual channel ready signals from the receiver to the transmitter include, but are not limited to:

If no frame is currently being transmitted from the receiver to the transmitter, a virtual channel ready message is sent using a special MAC Control frame. The message packet may include one or more n-tuples. Each n-tuple may include the virtual channel number and the corresponding number of credits (“virtual channel readies”) that have become free. The “virtual channel readies” may be computed dynamically for each channel at the time the “readies” need to be transmitted. Note the number of n-tuples transmitted may depend on the number of virtual channels supported (IgVC) and some data alignment considerations. For any virtual channel that is not supported, but for which an n-tuple is transmitted, the value of credits is zero.

If a frame is currently being transmitted from the receiver to the transmitter a virtual channel ready message may be piggybacked on the outgoing packet. In one embodiment, adding a specific Ethertype to the frame may allow the frame to be identified as a packet of a specific type. An opcode may be used to identify the presence of virtual channel credits. N-tuples similar to those described above may be added to convey the “virtual channel readies.”

Virtual Channel Credit Synchronization

Because of unreliable communication (Bit Error rate may eventually show up), packets on a link may be corrupted and as such “lost”. If packets that include virtual channel ready information become corrupted, credits may be lost, potentially resulting in a deterioration of transmission rate. Eventually, if all the credits are lost, transmission of packets over the link will stop. In order to avoid this problem, a credit synchronization procedure is preferably provided for network switches implementing virtual channels and using credit-based flow control for Gigabit Ethernet ports.

Under some conditions, including but not limited to the following, the transmitting network switch (originator of frames over the virtual channel) may activate the credit synchronization procedure:

On a timeout determined by the SyncTimeOut register if it is enabled.

On an explicit command by the management CPU.

On detecting a frame error, such as a frame-check sequence (FCS) or cyclic redundancy check (CRC) error, on any frames received from the receiver. Note that the receiver's link to the transmitter may or may not carry virtual channels.

On receiving a Frame Error Detected (FED) indication in a frame from the receiver. In one embodiment, this may be indicated by an FED bit in a received frame.

On a timeout determined by a timer mechanism (e.g. a SyncAckTimeOut register), if enabled.

One embodiment of a credit synchronization procedure for virtual channels in the network switch is described below.

Under the conditions listed in items 1, 2, 3 or 4 above, a credit synchronization message may be sent by a first network switch to a second network switch using a special MAC Control frame. A second timer (e.g. the SyncAckTimeOut register) may be initialized and started, and the SyncCount register may be initialized to 1. Also, one or more SyncRdyCount registers (1 per virtual channel being supported) may be initialized to zero. For each of the virtual channels currently supported, the credit synchronization message may include the current value of the EgCreditCount register. For virtual channels that are not currently supported, the values of the credits sent are zero. Until the credit synchronization acknowledgement message is received by the first network switch, the SyncRdyCount registers may be incremented every time EgCreditCount is incremented.

Upon receiving the credit synchronization message, the second network switch may transmit a credit synchronization acknowledgement message using a special MAC Control frame. In one embodiment, this message may include the information that was received in the credit synchronization message. The credit synchronization acknowledgement message may also include, for each of the virtual channels, the current value of the BuffersAvailable register. The value in the BuffersAvailable is the current number of buffers currently available in the fabric for that virtual channel, i.e. the difference between the packets available in the fabric for that virtual channel minus the number of packets that are in the ingress block for that virtual channel. For virtual channels that are not supported, this value may be zero. The IgCreditCount registers may also be updated.

Upon receiving the credit synchronization acknowledgement message, the first network switch may stop the SyncAckTimeOut register, and also may initialize and start the SyncTimeOut register. The first network switch may also clear the SyncCount register. The first network switch may also update the egress credit count registers (EgCreditCount) for each of the virtual channels by performing a calculation such as that shown below. The calculation is shown for virtual channel 0. Using the _{CSA} subscript identifies the values that are used from the credit synchronization acknowledgement message:

EgCreditCount[0]={IgCreditCount[0]_{CSA}−EgCreditCount[0]_{CSA}}+{EgCreditCount[0]−SyncRdyCount[0]}

The EgCreditCount[0]_{CSA} used in the equation above is the value that was sent in the original credit synchronization message and reflected back in the credit synchronization acknowledgement message and is the value of the register at the transmitter. The IgCreditCount[0]_{CSA} used in the equation above is the value that that was sent over in the credit synchronization acknowledgement message and is the value of the register at the receiver.

If SyncTimeOut expires, it may be assumed that either the credit synchronization message or the credit synchronization acknowledgement messages has been lost. In this case, a second credit synchronization message may be sent similar to that described above. Also, the SyncTimeOut register may be reinitialized and restarted, and the SyncCount register may be incremented. This may be repeated if SyncTimeOut expires again. In one embodiment, after several expirations, it may be assumed that there is something wrong with the link. The management CPU may be informed of the link's inability to do credit synchronization. In one embodiment, this may be done after 3 expirations, identified by the expiration of the timer and the SyncCount register having a value of 3.

In the mechanism described above, there is no provision for receiving out-of-order credit synchronization acknowledgement messages. An acknowledgement message may be lost, and recovery from it is possible at least twice. However, in one embodiment, it is not likely that messages will get out of order or reappear after being lost, since these messages are processed by the GEMAC and do not go into the fabric. There is preferably only one set of SyncRdyCount registers. As such, back-to-back credit synchronization messages may preferably be scheduled with enough delay between them so that an acknowledgement for an earlier message can preferably never be received after a new synchronization message has been sent. This may especially be true when the credit synchronization procedure is initiated due to items 2, 3 or 4 from the list of causes that may initiate synchronization messages.

Virtual Channel Deactivation

On the detection of certain error conditions during login, credit initialization or credit synchronization, the management CPU may want to deactivate the virtual channels. In one embodiment, a deactivation message may be sent. This message may be sent one or more times with a programmed delay value. No acknowledgement is expected. After sending the last message, the link may either be deactivated or may revert back to a standard Gigabit Ethernet link.

Keeping Track of Credits for Virtual Channels

Keeping track of credits, both at the transmitter and the receiver, is preferably done so as to not advertise either more credits (resulting in running out of resources and as such dropping packets) or fewer credits (reducing the effective utilization of the link) than are actually available. This computation may be complicated by the different asynchronous clock domains within a slice of the network switch. For example, the GEMAC may operate in a different clock domain than the fabric and the ingress and egress blocks. Thus, calculating credits (which requires signals that cross clock domains) preferably accounts for the differences in time due to the asynchronous clocks.

In one embodiment EgCreditCount registers, at the transmitter, may be decremented when a frame leaves the switch. Once the GEMAC is committed to sending the frame for a particular virtual channel, it may update the appropriate EgCreditCount register. EgCreditCount registers may have the received VCReady values added to them once the frame, which brought the values over from the receiver, has been accepted error free by the GEMAC. Similarly the GEMAC may update the EgCreditCount register as a result of receiving the credit synchronization acknowledgement frame error free. Reading and writing of the EgCreditCount register are preferably interlocked in such a way so as to never have an incorrect value in it.

IgCreditCount registers, at the receiver, may be decremented when a frame arrives at the switch (with or without an error). Once the GEMAC is committed to sending the frame to the ingress block, the register for the appropriate virtual channel may be decremented. IgCreditCount registers may get the transmitted VCReady values added to them once the frame, containing the VCReady values, is committed by the GEMAC to flow out of the switch. Similarly the GEMAC may update the IgCreditCount register as a result of receiving the credit synchronization frame error free. Reading and writing of the IgCreditCount register is preferably interlocked in such a way so as to never have an incorrect value in it.

A credit synchronization frame is preferably processed by the ingress GEMAC and ready to be transmitted to the ingress block before the VCReady values, preferably sent back in the acknowledgement message, are determined. This is preferably synchronized with any updating of the IgCreditCount registers, which may occur because of existing outgoing VCReady values.

For each virtual channel being supported, the Input block may send a value (e.g. via a 10 bit bus) indicating the number of packet descriptors (and as such buffers) that are available in the fabric. The ingress block may track how many packets it has for each virtual channel currently in its FIFOs. Subtracting this number from the number that was sent over from the Input block, for a particular virtual channel, gives the number of buffers that are available for that virtual channel. This number may then be sent to the GEMAC (via the BuffersAvailable signals) for it to keep track of credits available, etc. In one embodiment, a programmable watermark register may be used to reduce the effective value of the BuffersAvailable signals in the GEMAC. This may help in accounting for any miscounting (in time) because of the different clock domains that the signals are crossing.

For each virtual channel being supported, the GEMAC may send the value of the EgCreditCount register to the egress block. The egress block may track how many packets it has for each virtual channel currently in its FIFOs. Subtracting this number from the number that was sent over from the GEMAC, for a particular virtual channel, gives the number of credits that are available for that virtual channel effectively at the egress block. These numbers may then be sent to the Output block. The Output block also may track how many packets it has for each virtual channel currently in its FIFOs. Subtracting this number from the number that was sent over from the egress block, for a particular virtual channel, gives the number of credits that are available for that virtual channel effectively at the Output block. The Output block may use these signals to determine whether it can schedule packets for a particular virtual channel.

Virtual Channel Credit Rules

Rules for keeping track of credits may include, but are not limited to, the following. The rules preferably apply to each virtual channel individually:

1. When a packet is scheduled out in the egress direction on a particular virtual channel, the appropriate EgCreditCount register is decremented by one. MAC Control frames are not counted.

2. When a virtual channel ready message is received, the credit values in the message for each virtual channel are added to the EgCreditCount register values.

3. When a packet is received on a particular virtual channel, the appropriate IgCreditCount register is decremented by one.

4. When a virtual channel ready message is sent, the values in the message are used to update the appropriate IGCreditCount registers.

5. If the effective value of an EgCreditCount register for a particular virtual channel reaches zero, packet transmission on that virtual channel is stopped.

6. Packet transmission on a virtual channel is started once the effective EgCreditCount register value becomes larger than zero.

7. The number of buffers available for a particular virtual channel (BuffersAvailable) is the difference between the packets available in the fabric for that virtual channel minus the number of packets that are in the ingress block for that virtual channel.

8. If the value of IgCreditCount is less than BuffersAvailable, then VCReadys may be sent over to the transmitter for that particular virtual channel and IgCreditCount may be updated. The following calculated may be performed:

Number of VCReadys to be transmitted=BuffersAvailable−IgCreditCount IgCreditCount=BuffersAvailable

9. When a credit synchronization message comes in, the following calculation may be performed for each of the virtual channels:

IgCreditCount=BuffersAvailable

The values of the IgCreditCount registers that are transmitted in the credit synchronization acknowledgement message are the ones that are computed above.

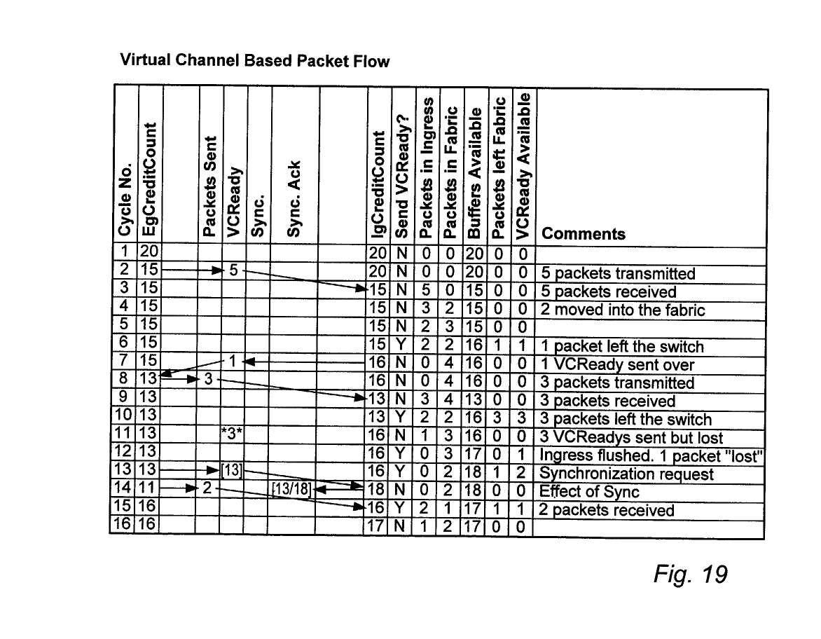

FIG. 19 is a table illustrating an example of virtual channel based credit flow through several cycles according to one embodiment. The example is of transmission in a single direction for a single virtual channel. In the table, cycle numbers refer to the individual rows with time increasing from the smaller numbers towards the bigger numbers. References to transmitter and receiver imply the transmitter and receiver of virtual channel based packets. A number of things to note about the example are:

The effect of packets leaving the transmitter is seen immediately on EgCreditCount while its effect on IgCreditCount at the receiver is seen in the next cycle.

The effect of VCReady leaving the receiver is seen immediately on IgCreditCount while its effect on EgCreditCount at the transmitter is seen in the next cycle.

Credit synchronization message (identified by the Sync. column in the table) arrives at the receiver one cycle after it leaves the transmitter.

credit synchronization Acknowledge message (identified by the Sync. Ack column in the table) arrives at the transmitter one cycle after it leaves the receiver.

The number in the Sync. column is the value of the EgCreditCount register that is sent in the credit synchronization message by the transmitter.

The two numbers in the Sync. Ack column are the original number that came over in the credit synchronization message and the IgCreditCount register value when the receiver sent the credit synchronization acknowledgement message.

At cycle 1, EgCreditcount, IgCreditCount and Buffers Available are initialized to the negotiated credit count between the transmitter and the receiver. In the example, this number happens to be 20. At cycle 2, five packets are sent from the transmitter to the receiver. This is immediately reflected in the value of EgCreditCount, which is reduced by five to 15. At cycle 3, the five transmitted packets are received at the receiver. The value of IgCreditCount and Buffers Available is reduced by five to 15. The five packets end up in the ingress block.

At cycle 4, two packets move from the ingress block to the fabric. At cycle 5, another packet moves into the fabric. At cycle 6, one packet leaves the fabric. Buffers Available increases by one to 16. A single VCReady is available to be sent over to the transmitter.

At cycle 7, the single VCReady is sent to the transmitter. This is immediately reflected in the value of IgCreditCount, which is increased by one to 16. At cycle 8, the single VCReady is received at the transmitter. At the same time three packets are transmitted. The net effect of this is to reduce the value of EgCreditCount by two (15+1−3=13) to 13.

At cycles 9 and 10, the three packets are received at the receiver. Three packets also leave the fabric resulting in three VCReadys being available. At cycle 11, the three VCReadys are sent over to the transmitter. This is immediately reflected in the value of IgCreditCount, which is increased by three to 16. However the VCReady packet is lost.

At cycle 12, no update of the EgCreditcount takes place since the VCReady packet is lost. The ingress block does a flush and loses a single packet. This is immediately reflected in the Buffers Available value increasing by one to 17. Note that the VCReady Available value reflects any changes in packets either leaving the fabric or getting flushed out of the ingress block. At this stage because of the lost VCReady packet the transmitter and the receiver credits are out of synchronization. At cycle 13, a credit synchronization message is sent with the current value [13] from the transmitter to the receiver.

At cycle 14, the credit synchronization message is received at the receiver. In response to this, the Buffers Available value [18] is stored in the credit synchronization acknowledgement (along with the original value that came over) and sent to the transmitter. The Buffers Available value is also stored in IgCreditCount. The VCReady Available value is cleared to zero. In the same cycle, the transmitter sends over two packets reducing the EgCreditCount to 11. At cycle 15, the credit synchronization acknowledgement is received at the receiver. The value of EgCreditCount is updated to 16 [18−(13−11)=18−2=16]. Also two packets are received at the receiver and IgCreditCount is reduced to 17.

Virtual Channel Frame Errors

Frames involved in any of the procedures described above may have FCS or CRC errors. Depending on the types of the frame, one of the following may be performed when frames with errors are received:

For login, credit initialization and the corresponding acknowledgement frames the complete frame is passed to the management CPU. It is the responsibility of the management CPU software to deal with this issue.

For virtual channel ready frames, the virtual channel related registers that would normally get updated are not updated. The error is counted and an interrupt to the management CPU is generated.

For credit synchronization frames, the virtual channel related registers that would normally get updated are not updated. No acknowledgement frame is transmitted. The error is counted and an interrupt to the management CPU is generated.

For credit synchronization acknowledgement frames, the virtual channel related registers that would normally get updated are not updated. The error is counted and an interrupt to the management CPU is generated.

For Deactivation frames, the complete frame is passed to the management CPU. It is the responsibility of the management CPU software to deal with this issue.

On receiving normal virtual channel frames, the appropriate IGCreditCount register is decremented, irrespective of any kinds of errors in the frame. In some cases (for example, if the frame error corrupted the virtual channel number of the frame) this may result in virtual channel frames being dropped.

Virtual Channel Frame Formats

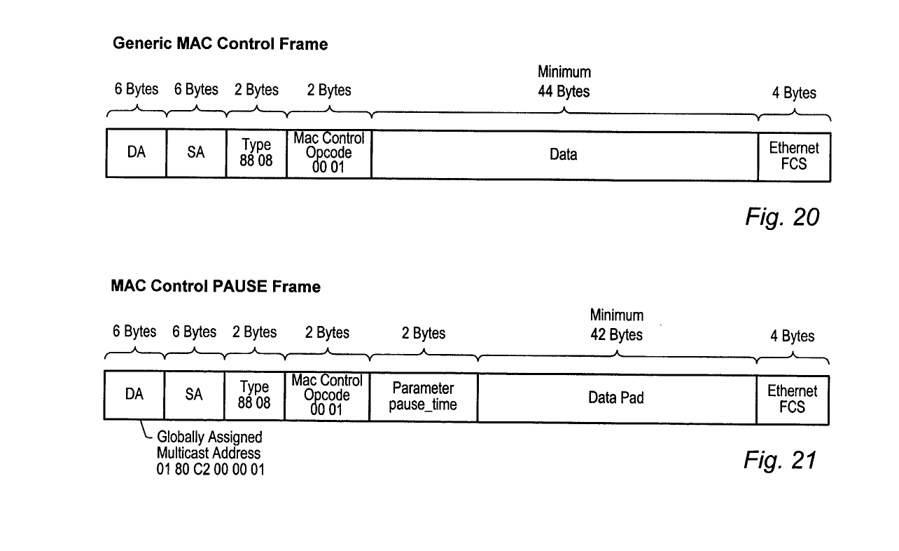

This section provides details of embodiments of frame formats that may be used for the various virtual channel related messages. The messages may use MAC Control frames to transfer network switch-specific information. A generic MAC Control frame is illustrated in FIG. 20.

The IEEE 802.3 standard only specifies a single value (out of a possible 65536 values) of the MAC CONTROL OPCODE field. This value is used in the MAC Control PAUSE frame. The format for one embodiment of a PAUSE frame is shown in the FIG. 21. The opcode for the PAUSE frame is 00 01. The pause_time parameter is a two-byte unsigned integer containing the length of time for which the receiver is requested to inhibit frame transmission.

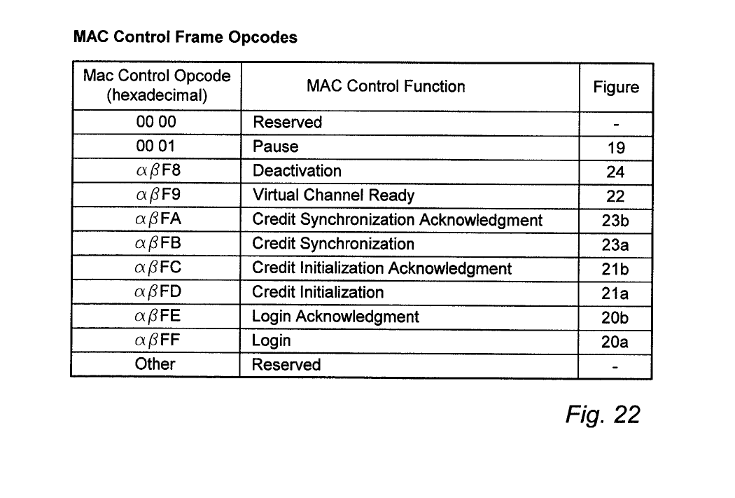

According to the IEEE 802.3 standard, a switch receiving a MAC Control frame with an opcode value other than the one defined for the PAUSE frame is supposed to ignore the frame and throw it away. As such, network switches as defined herein may define inter-switch MAC Control frames, which can use one or more of the unused opcodes (65535 possible values) to communicate network switch-specific information. If the frame goes to a network switch not programmed to understand these opcodes, the receiving switch will ignore it and throw it away. FIG. 22 lists examples of opcodes that may be defined for network switch-specific usage. The upper byte of the opcode is identified as αβ. In one embodiment, this byte is obtained from a programmable 8-bit register. Using the upper bytes, the network switch-specific MAC Control frame opcodes may be moved around in the opcode space to avoid any future conflicts, for example, with possible future IEEE-standard defined opcode usage.

For the embodiments of frames as described herein, reference to the least significant bit of a field means that it is the last bit of the field to be transmitted or received. Reference to the most significant bit of a field means that it is the first bit of the field to be transmitted or received. If a value is smaller than the field that it is being stored in, then it may be right justified with the least significant bit of the value being stored in the least significant bit of the field. The unused most significant bits may be set to zero.

MAC control frames may have a special globally assigned multicast address as the destination address. A switch receiving such a frame will not “multicast” the frame. Prior to starting the login process, a network switch which desires to have virtual channels on a particular Gigabit Ethernet link may send PAUSE(0) frames. In this manner, if the other side is a network switch that supports virtual channels and that also wants to establish virtual channels on that link, may obtain the destination MAC address to be used from the source address on the PAUSE(0) frame. Since MAC control frames may use either the special globally assigned multicast address or the explicit destination MAC address, the following conventions are preferably followed:

A MAC Control frame that has the globally assigned multicast address as its destination address is processed by the GEMAC.

A MAC Control frame that has the actual MAC destination address is passed to the management CPU for processing.

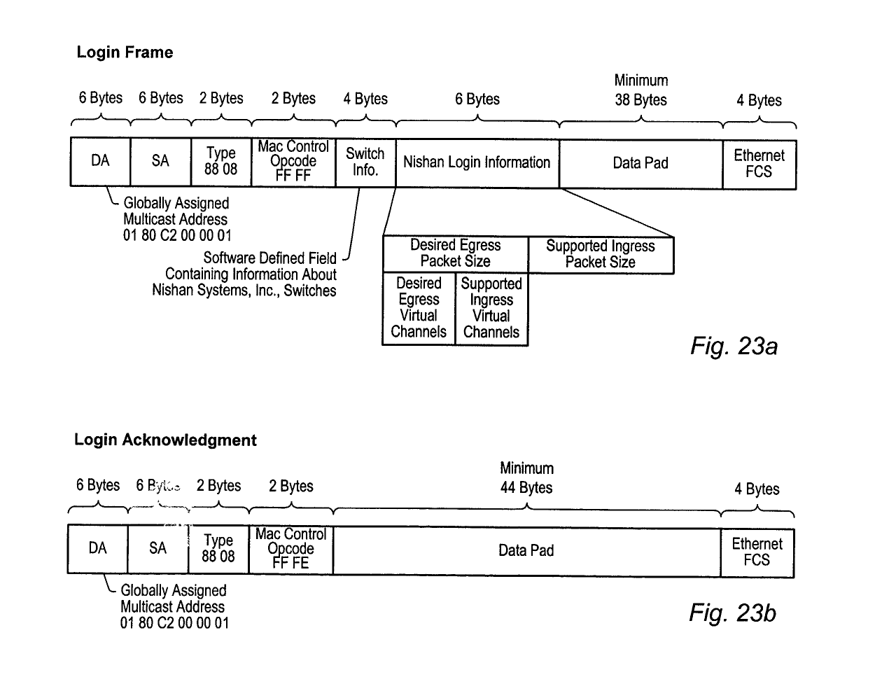

One embodiment of a login frame format is illustrated in FIG. 23a. The destination address (DA) field specifies the actual destination address. On receiving this frame, a network switch preferably passes the frame to the management CPU. The 4 bytes of SWITCH INFO is a software-defined field used to communicate switch specific information that may be used by the network management software. The DESIRED EGRESS PACKET SIZE is a 16-bit field that may specify a packet size of up to 65536 bytes. The SUPPORTED INGRESS PACKET SIZE is a 16-bit field that may specify a packet size of up to 65536 bytes. A value of zero in any of the fields may indicate that virtual channels are either not being requested or are not supported in the egress or in the ingress direction respectively. The DESIRED EGRESS VIRTUAL CHANNELS is an 8-bit field that may specify up to 256 virtual channels. The SUPPORTED INGRESS VIRTUAL CHANNELS is an 8-bit field that may specify up to 256 virtual channels. In one embodiment that supports up to eight virtual channels, the least significant three bits of the 8-bit field identify up to eight virtual channels and the upper five bits are always zero. A value of zero in any of the fields indicates that virtual channels are either not being requested or are not supported in the egress or in the ingress direction respectively. Note that the absence of virtual channels may be indicated by one or both of the two mechanisms described above

On receiving a login frame, a network switch, if so enabled may send a login acknowledgement frame back to the original switch. One embodiment of a login acknowledgement frame format is illustrated in FIG. 23b. The destination address (DA) is the actual MAC address of the destination.

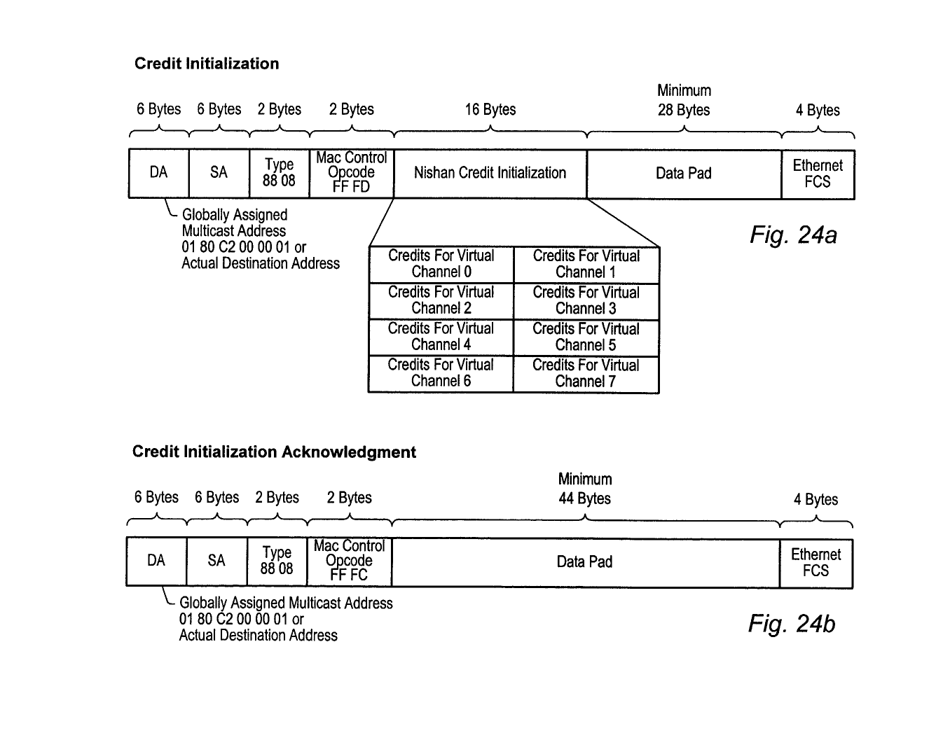

FIG. 24a illustrates one embodiment of a credit initialization frame format. A two-byte field per virtual channel may be used to indicate the number of credits that the receiver is allocating the transmitter. In on embodiment, the maximum credits that may be allocated to the transmitter are 4096, which requires at least a 12-bit field. This field is stored in the least significant bits (e.g. 12 bits) of the field with the upper bits (e.g. 4 bits) being all zeroes. The first field (CREDITS FOR VIRTUAL CHANNEL 0) gives the credits for virtual channel zero; the second field (CREDITS FOR VIRTUAL CHANNEL 1) gives the credits for virtual channel one, and so on. Virtual channels not currently supported have a credit value of zero.

On receiving a credit initialization message, the receiving switch may send a credit initialization acknowledgement message back to the original switch. One embodiment of a credit initialization acknowledgement frame format is shown in FIG. 24b. The destination address (DA) is the actual MAC address of the destination.

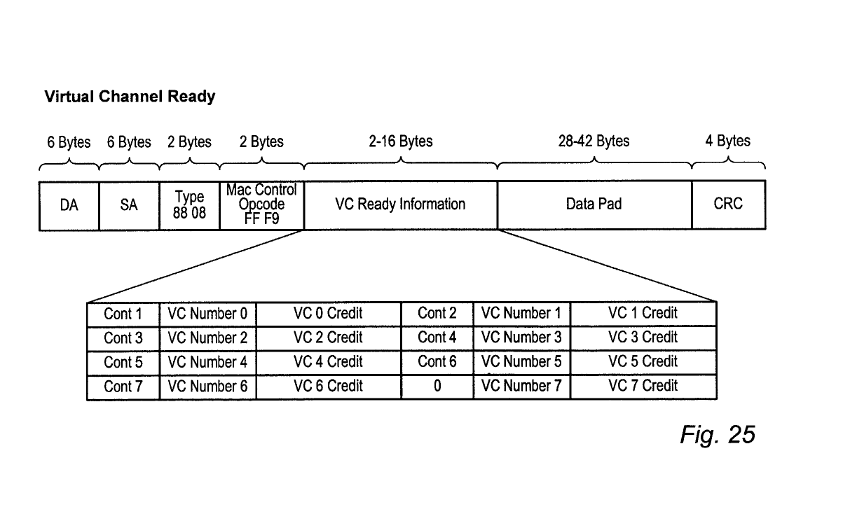

One embodiment of a virtual channel ready frame is shown in FIG. 25. This frame is transmitted only when there is no outgoing traffic on a link and there are outstanding VCReadys (credits) that need to be transferred to the transmitter. Credit information for each supported virtual channel may be conveyed in a 2-byte field. The least significant bits (e.g. 12 bits) of the field may contain the number of credits. Unused bits may be set to zero. This field is identified as VC n CREDIT in FIG. 25. In one embodiment that supports up to 8 virtual channels, n may specify a value from 0 to 7. The next bit field (VC NUMBER n) identifies the virtual channel number. The most significant bit is the CONT n bit. If this bit is a one then there is another 2 byte field containing the credits for the next virtual channel. If this bit is a zero then this is the last 2-byte field containing credits. One embodiment allows the frame to convey credit information in any order for those virtual channels for which there are outstanding credits. In this embodiment, each 2-byte field contains the virtual channel number along with the corresponding number of credits. In one embodiment, all eight 2-byte fields are transmitted in the order in which they are shown in FIG. 25. Preferably, in either embodiment, at least one of the credit fields has a non-zero value.

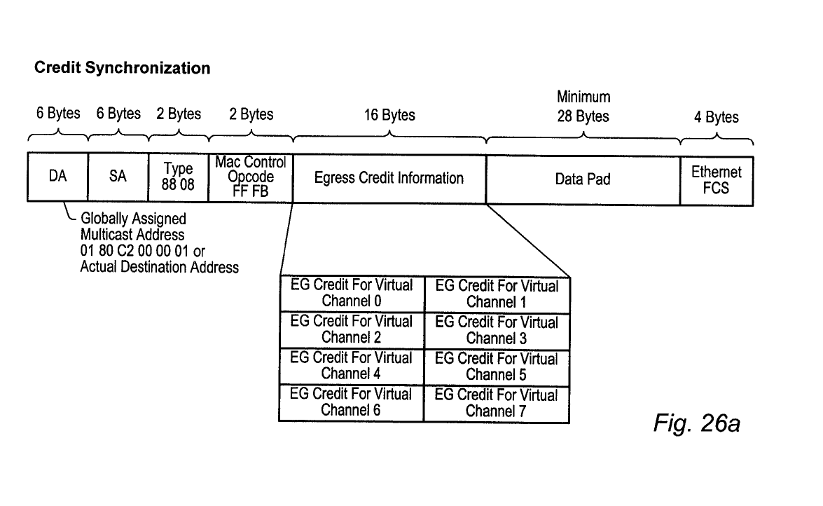

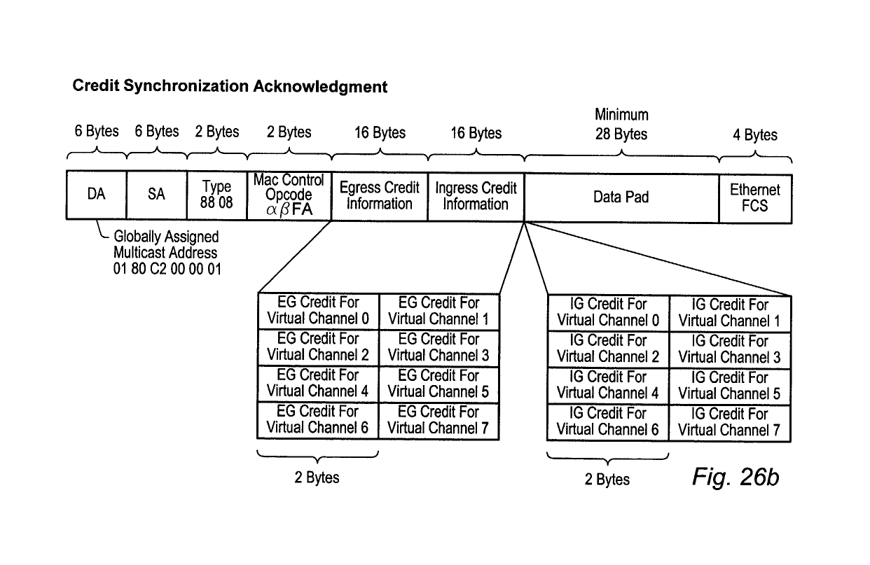

One embodiment of a Credit synchronization frame format is illustrated in FIG. 26a. For each of the virtual channels there is a 2-byte field (EG CREDITS FOR VIRTUAL CHANNEL n) that may include the value of the EgCreditCount register at the time the frame is transmitted. Preferably, for virtual channels not being supported this value is zero.

One embodiment of a credit synchronization acknowledgement frame format is illustrated in FIG. 26b. This frame may include an EGRESS CREDIT INFORMATION group, which includes the information from the field with the same name from a received credit synchronization frame. Additionally for each of the virtual channels there is a 2-byte field (IG CREDITS FOR VIRTUAL CHANNEL n) that may include the value of the IgCreditCount register at the time the frame is transmitted. Preferably, for virtual channels not being supported this value is zero.

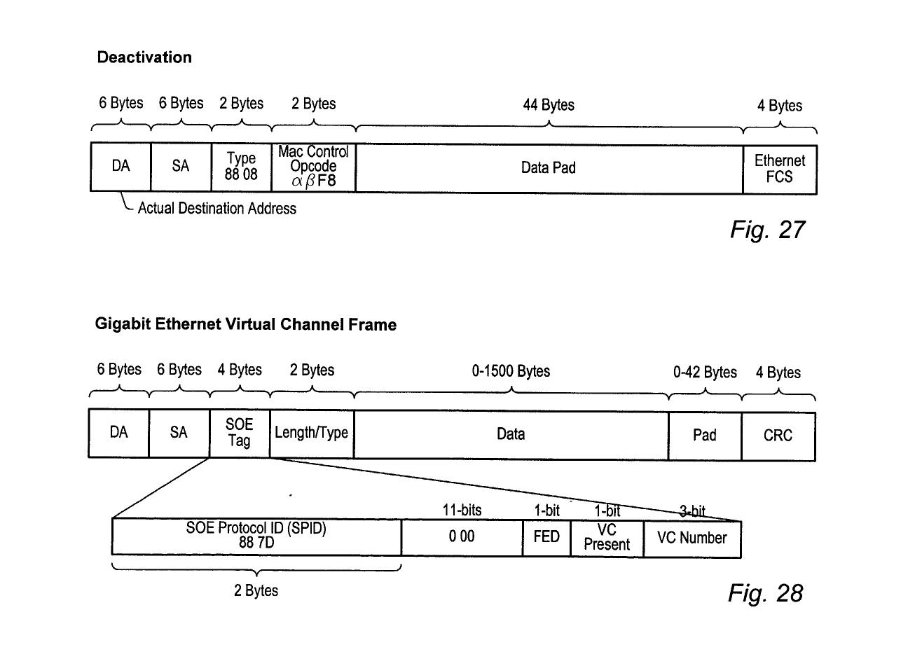

FIG. 27 illustrates one embodiment of a Deactivation frame format. On the detection of certain error conditions during login, credit initialization or credit synchronization, the management CPU may a Deactivation message may be sent. This message may be sent one or more times, preferably three times, with a programmed delay value. No acknowledgement is expected. On receiving the Deactivation message, the receiving network switch, if so enabled, may pass the special MAC Control frame to the management CPU. After sending the last message, the link may be either deactivated by the management CPU, or the link may revert back to a standard Gigabit Ethernet link.

A frame may be classified to be transmitted on a particular virtual channel at the transmitter by the output scheduler of the Output block. In order to carry the virtual channel number in a Gigabit Ethernet packet, a new type of frame format has been defined. This frame format uses a special 4-byte “type” (Ethertype) tag, allocated by the IEEE, called the SOE tag. FIG. 28 illustrates one embodiment of a Gigabit Ethernet virtual channel frame using the SOE tag. The SOE TAG field is comprised of a 2-byte SOE PROTOCOL ID field that has an assigned, predefined value (e.g. 88 7D). The next 11-bit field, the OPCODE, includes the value 0 00. Next is the FED indicator bit field that is described below. The next bit (VC PRESENT), if 1, indicates that this packet belongs to a virtual channel that is given in the next bit field, VC NUMBER. In one embodiment, if the VC PRESENT bit is 0, then the VC NUMBER bits have no meaning. In one embodiment supporting 8 virtual channels, the VC NUMBER field is at least 3 bits.

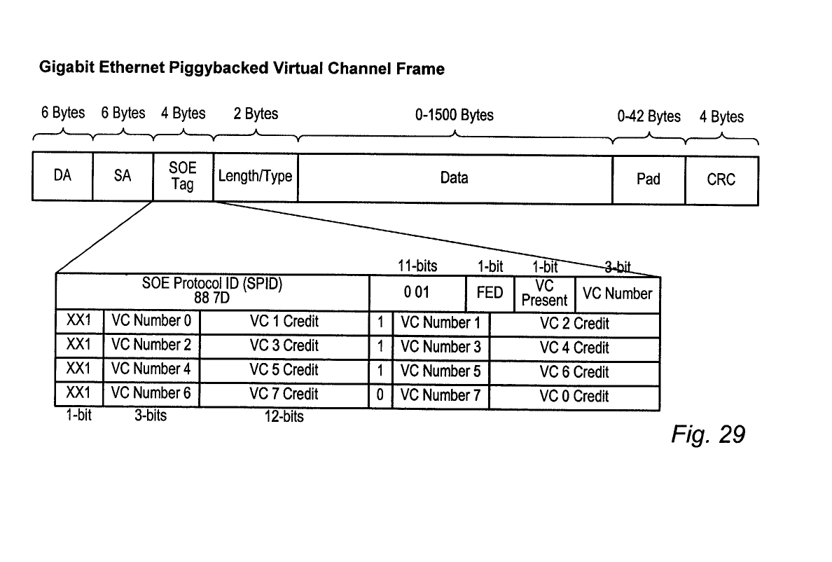

In one embodiment, credit information (VCRDYs) may also be piggybacked onto a Gigabit Ethernet frame as illustrated in FIG. 29. This frame may also include a SOE TAG field as described above. As in FIG. 28, the SOE PROTOCOL ID FIELD includes the predefined value (e.g. 88 7D). The opcode field is 0 01, identifying a frame that contains piggybacked credit information. FED, VC PRESENT and VC NUMBER fields have the same meanings as in FIG. 28. Following this, each two bytes may include information about the virtual channel for which credits are being sent to the transmitter from the receiver. The first bit is effectively a continue bit. If it is 0 it means that there are no subsequent credit-carrying bytes, else if it is 1 there are two more bytes carrying credit information. The next bit field, VC NUMBER n, indicates the virtual channel number. The remaining bit field, VC n CREDIT, include the credits being transferred for that particular virtual channel. Preferably, only virtual channels for which credit information is outstanding at the receiver are included in this frame, i.e., a credit count of zero is preferably never transferred. In one embodiment, since each two-byte “packet” includes the virtual channel number along with the credit information, the information may be packed in any order. In one embodiment, a multiple of 4-bytes is always transmitted, and the information is always ordered as shown in FIG. 29. Thus, in this embodiment, channels for which there are no outstanding credits may be present (with a credits value of zero) in the piggybacked frame.

Virtual Channel Frame FED Indicator

FED stands for “Frame Error Detected at the receiver.” The FED indicator may be sent in a Gigabit Ethernet virtual channel frame to indicate to the transmitter that the receiver received a frame (other than login, credit initialization and deactivation related frames) from the transmitter in which was detected an error (e.g. an FCS or a CRC error). The FED indicator may cause the transmitter to schedule a credit synchronization procedure. In one embodiment, the FED indicator may be one bit, which may be set (1) to indicate an error was detected. Note the receiver may not have any virtual channels enabled in the egress direction (from it to the transmitter). However this does not prevent it from converting a standard Gigabit Ethernet frame into a Gigabit Ethernet virtual channel frame with the VC PRESENT bit equal to a 0 and the FED bit set to indicate frames received from the transmitter with detected errors.

Virtual Channel Output Scheduling

When an output port receives a packet to be scheduled, it can be placed on any one of its output queues. The output scheduler's function is to choose one of the output queues that is nonempty and is also eligible to be scheduled.

The output scheduler is designed to be as flexible as possible. By varying the configuration registers, one or more of the following behaviors may be achieved:

Low jitter weighted fair queuing

Pure priority scheduling

Hybrid weighted fair queuing/priority scheduling

Guaranteed minimum bandwidth for a single queue

Guaranteed minimum shared bandwidth for a group of 8 queues

Guaranteed minimum shared bandwidth for a group of 128 queues

Maximum bandwidth regulation for a group of 8 queues

Maximum bandwidth regulation for a group of 128 queues

Maximum bandwidth regulation for the port

Multi-lane flow control per group of 8 queues

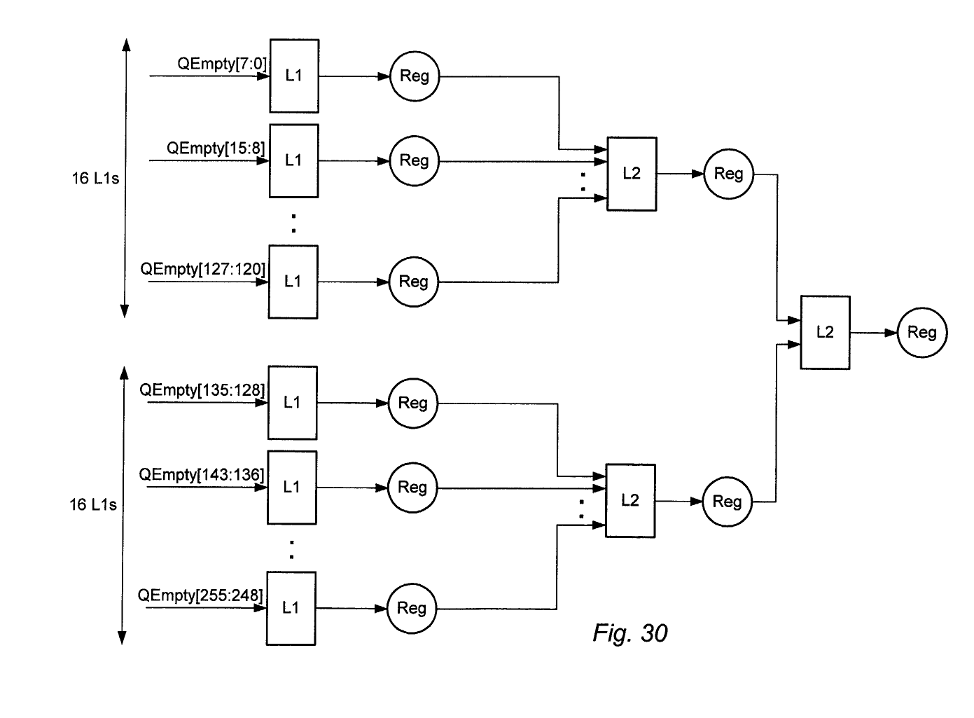

The output scheduler is made up of a hierarchy of smaller schedulers, connected in a manner such that the previously mentioned configurations are possible. A block diagram of one embodiment of the output scheduler architecture supporting 256 output queues is shown in FIG. 30. In this embodiment, the scheduler is composed of 32 L1 schedulers, 32 L1 regulators, 2 L2 schedulers, 2 L2 regulators, 1 L3 scheduler, and an L3 regulator. An L1 scheduler takes as input the empty bits from 8 of the output queues. The empty bit is asserted if that particular output queue is empty, and it is de-asserted if it contains one or more packets awaiting scheduling. In one embodiment, the L1 scheduler then uses a weighted-fair-queuing method to select one of the non-empty queues to be scheduled. There are 32 L1 schedulers, with 8 queues for each scheduler, covering all of the 256 output queues. The output of an L1 scheduler is an Empty bit, which indicates if all of the 8 queues are empty, and a queue number, which indicates the selected queue in case there exists at least one non-empty queue.

Queues may use weighted fair queuing (WFQ). As an example of weighted fair queuing, suppose for a 1 Gb/s port, 4 of the queues (2, 4, 6 and 8) are used, and they are all attached to the same L1 scheduler (number 5). It is desired that 2 and 4 should each have a minimum of 10 MB/s of bandwidth, 6 should have 30 MB/s, and 8 should have 15 MB/s. There is no other priority specified for the queues, other than the relative desired bandwidths. The resulting value for the Srvcinterval registers may be:

SrvcInterval_L1_{—}5_{—}2[7:0]=30/10=3

SrvcInterval_L1_{—}5_{—}4[7:0]=30/10=3

SrvcInterval_L1_{—}5_{—}6[7:0]=30/15=2

SrvcInterval_L1_{—}5_{—}8[7:0]=30/30=1

When programming an L1 scheduler, the ratio between different queues on the scheduler in the time domain is being specified. Using bandwidths is one way to express these ratios. In general, the least common multiple (LCM) of all of the weights needs to be found. Then, the LCM is divided by each of the individual weights to form each of the Service Intervals. In the previous example, the LCM is 30, and it is divided by each of the weights to form the Service Intervals. These values can be scaled upward or downward to a maximum of 8-bits (255) in order to use maximum possible precision. Effectively, the resulting values are simply ratios, and not true bandwidths, as there are other blocks between the L1 and the output that can affect the achieved bandwidth.

Queues may also use strict priority scheduling. Each queue on an L1 scheduler has an implicit priority. In one embodiment, the lower the queue number, the higher the priority, with queue 0 having the highest priority and queue n (e.g. 7) having the lowest priority. Priority is used whenever there exists more than one queue with exactly the same Next Service time. In such a case, the highest priority queue is chosen. In one embodiment, this behavior may be exploited to cause true priority scheduling by making the Service Interval for such a queue equal to 0. In this case, the queue, whenever it is non-empty, will always have a next service time that is the minimum of all the non-empty queues. In the case of more than one queue that has a Service Interval of 0, then the internal priority may be used to select between them.

An L1 scheduler may have some queues that use strict priority and some that use Weighted Fair queuing (WFQ). Preferably, the strict priority queues are the lowest numbered queues and have Service Intervals of 0. Preferably, any queues that desire WFQ to share the remaining bandwidth use the next higher numbered queues and have non-zero Service Intervals.

To support Gigabit Ethernet virtual channels, each L1 scheduler may be associated with one of the K virtual channels. In one embodiment, K=8. In on embodiment, this association may be configured by setting the 4 bit registers VcNumL1_x[3:0], where x is from 0-31 for the 32 different L1 schedulers. The most significant bit of these registers, when asserted, may indicate that the L1 scheduler is associated with a virtual channel, and the lower bits indicate which virtual channel. In embodiments that support up to 8 virtual channels, at least 3 bits are required to indicate which virtual channel. When associated with a virtual channel, the L1 scheduler preferably observes the values of the incoming credit signals, passed along from the output FIFO of the Output Block. When the incoming credit becomes zero for the respective virtual channel to which the L1 scheduler is attached, the L1 scheduler may artificially assert Empty to the downstream logic to ensure that no packets are scheduled on a virtual channel that has no outstanding credits.

Scheduling Packets for Virtual Channels

Since flow control for Gigabit Ethernet virtual channels is based on credits, a packet destined for such a port preferably only leaves the sending network switch when there is a corresponding credit available for it. For virtual channel packets, L1 schedulers may be associated with individual virtual channels as described above. In this case, the L1 schedulers observe the outstanding available credits to determine if it is appropriate to schedule packets or not. This also may prevent one virtual channel that has no outstanding credits from blocking another virtual channel that has available outstanding credits.

For port mode 2, the GEMAC may provide the egress block with the number of free credits (packets) over the signals gm_EgFreePktDscX (where X is the virtual channel number). The egress block then may determine how many packets it has available for each of the virtual channels in its various FIFOs and subtracts this number from the number provided to it by the GEMAC. This is the effective number of free credits at the output of the egress block. This information is provided by the egress block to the fabric's output block over the signals eg_ObFreePktDescVCX[11:0] (where X is the virtual channel number). The output block then may reduce the count further by taking into account any packet it has in its Output FIFO for each of the virtual channels. This information may then be passed to the output scheduler. If the number is positive (i.e., there are credits) for a particular virtual channel, the scheduler may schedule packets for that virtual channel. If the number is zero (i.e., there are no credits) the scheduler may not schedule any more packets for that particular virtual channel until credits become available.

Ingress Block Frame Tag FIFO and Virtual Channels

Each ingress block may include a Frame Tag FIFO. In one embodiment, the Frame Tag FIFO may be made up of discrete flip-flops, and may hold a number of different tags that may be associated with the frame headers that are passed to the network processor. In one embodiment, the Frame Tag FIFO is 32 words deep with each word being 24-bits wide. There are one or more tags that may be associated with each header frame that is passed to the network processor. The tags may include an n-bit virtual channel ID that records the virtual channel on which the packet arrived. In one embodiment, n=4.

Early Forwarding and Virtual Channels

If a packet has not been cut-through then the packet can be early forwarded from a port if the packet comes in on a virtual channel and the total clusters available for the virtual channel on the input port is greater than or equal to the value of a programmable register (e.g. mp_MinFreeClstrsVCPort0123). Note that 8-bit sub-fields within this register may be associated with individual ports. Preferably, this register is programmed with a value that is greater than or equal to the maximum frame size in clusters for the largest packet that can come on that particular port. This ensures that a packet will not run out of clusters, after it has been early forwarded. The fabric preferably has buffered up enough data to prevent under-run on the output FIFO. This may be determined by calculating the maximum of the EarlyForwardingThreshold registers for all the destination ports and making sure that the amount of buffered up data is greater than this number. The EarlyForwardingThreshold registers are preferably programmed with non-zero values when going from a slower speed port to a faster speed port.

A system and method for providing virtual channels over links between network switches have been disclosed. While the embodiments described herein and illustrated in the figures have been discussed in considerable detail, other embodiments are possible and contemplated. It should be understood that the drawings and detailed description are not intended to limit the invention to the particular forms disclosed, but on the contrary, the intention is to cover all modifications, equivalents, and alternatives falling within the spirit and scope of the present invention as defined by the appended claims.

What is claimed is:

1. A method comprising:
establishing a network link between a first port on a first network switch and a second port on a second network switch;
determining if one or more virtual channels are supported on the network link;
if it is determined that the one or more virtual channels are supported on the network link:
determining a number of credits allocated for each of the one or more virtual channels on the network link;
transmitting a first one or more packet flows from the first network switch to the second network switch, wherein each of the first one or more packet flows is transmitted on a corresponding one of the plurality of virtual channels; and
performing credit-based flow control for each of the first one or more packet flows on the corresponding virtual channel using the number of credits allocated for the corresponding virtual channel on the network link.

2. The method as recited in claim 1, further comprising:
after said determining the number of credits allocated for each of the one or more virtual channels on the network link:
the first network switch receiving a second one or more packet flows from the second network switch, wherein each of the second one or more packet flows is transmitted on a corresponding one of the plurality of virtual channels; and
performing credit-based flow control for each of the second one or more packet flows on the corresponding virtual channel, wherein said credit-based flow control for the particular packet flow uses the number of credits allocated for the corresponding virtual channel on the network link.

3. The method as recited in claim 1, wherein said determining if the one or more virtual channels are supported on the network link comprises:
the first network switch sending one or more login frames to the second network switch; and
the second network switch sending one or more login acknowledgement frames to the first network switch in response to the one or more login frames sent from the first network switch.

4. The method as recited in claim 3, wherein each of the one or more login frames includes at least one of a requested number of egress virtual channels that the first network switch desires to establish on the network link, a supported number of ingress virtual channels supported by the first network switch on the network link, a requested egress packet size for each of the egress virtual channels that the first network switch desires to establish on the network link, and a supported ingress packet size for each of the ingress virtual channels supported by the first network switch on the network link.

5. The method as recited in claim 1, wherein said determining if the one or more virtual channels are supported on the network link comprises:
determining a number of egress virtual channels that are supported by the first network switch on the network link and an equal number of ingress virtual channels that are supported by the second network switch on the network link;
wherein each of the egress virtual channels on the first network switch is associated with exactly one of the ingress virtual channels on the second network switch.

6. The method as recited in claim 1, wherein said determining if the one or more virtual channels are supported on the network link comprises:
determining a number of egress virtual channels that are supported by the first network switch on the network link and a corresponding number of ingress virtual channels that are supported by the second network switch on the network link;
wherein each of the egress virtual channels on the first network switch is associated with exactly one of the ingress virtual channels on the second network switch.

7. The method as recited in claim 6, wherein said determining if the one or more virtual channels are supported on the network link further comprises:
determining a number of ingress virtual channels that are supported by the first network switch on the network link and a corresponding number of egress virtual channels that are supported by the second network switch on the network link;
wherein each of the ingress virtual channels on the first network switch is associated with exactly one of the egress virtual channels on the second network switch.

8. The method as recited in claim 1, further comprising:
if it is determined that the one or more virtual channels are supported on the network link:
calculating an egress packet size for each of the one or more virtual channels on the first network switch and a corresponding ingress packet size for each of the one or more virtual channels on the second network switch;
wherein the egress packet size for each of the one or more virtual channels on the first network switch is equal to the ingress packet size for the corresponding virtual channel on the second network switch.

9. The method as recited in claim 8, further comprising:
if it is determined that the one or more virtual channels are supported on the network link:
calculating an ingress packet size for each of the one or more virtual channels on the first network switch and a corresponding egress packet size for each of the one or more virtual channels on the second network switch;
wherein the ingress packet size for each of the one or more virtual channels on the first network switch is equal to the egress packet size for the corresponding virtual channel on the second network switch.

10. The method as recited in claim 1, wherein said determining the number of credits allocated for each of the one or more virtual channels on the network link comprises:
the first network switch sending one or more credit initialization frames to the second network switch; and
the second network switch sending one or more credit initialization acknowledgement frames to the first network switch in response to the one or more credit initialization frames sent from the first network switch.

11. The method as recited in claim 10, wherein the one or more credit initialization frames each include information on an allocated number of credits on the first network switch for each of the one or more virtual channels supported on the network link.

12. The method as recited in claim 1, wherein said determining the number of credits allocated for each of the one or more virtual channels on the network link comprises the first network switch and the second network switch each determining the number of credits allocated on the other network switch for each of the one or more virtual channels on the network link.

13. The method as recited in claim 1, wherein said performing credit-based flow control comprises tracking credit usage for each of the one or more virtual channels on both the first network switch and the second network switch.

14. The method as recited in claim 13, wherein said performing credit-based flow control further comprises stopping a packet flow on one of the one or more virtual channels if credits available for the packet flow on the virtual channel drop to zero.

15. The method as recited in claim 13, wherein said performing credit-based flow control further comprises synchronizing the tracking of credit usage for each of the one or more virtual channels between the first network switch and the second network switch.

16. The method as recited in claim 15, wherein said synchronizing comprises:
the first network switch sending a credit synchronization message to the second network switch, wherein the credit synchronization message includes a current number of unused credits for each of the one or more virtual channels being supported in the egress direction on the first network switch;
the second network switch sending a credit synchronization acknowledgement message to the first network switch in response to the credit synchronization message, wherein the credit synchronization acknowledgement message includes:
a current number of unused credits for each of the one or more virtual channels being supported in the ingress direction on the second network switch; and
the current number of unused credits for each of the one or more virtual channels received in the credit synchronization message.

17. The method as recited in claim 16, wherein said synchronizing further comprises:
the first network switch updating the current number of unused credits for each of the one or more virtual channels being supported in the egress direction on the first network switch;
wherein said updating uses the current number of unused credits for the particular virtual channel being supported in the ingress direction on the second network switch received in the credit synchronization acknowledgement message and the current number of unused credits for the particular virtual channel received in the credit synchronization acknowledgement message.

18. The method as recited in claim 1, wherein said performing credit-based flow control comprises the second network switch sending a virtual channel ready frame to the first network switch, wherein the virtual channel ready frame indicates available credits on the second network switch for receiving packets on the one or more virtual channels.

19. The method as recited in claim 1, further comprising transmitting a separate packet flow from the first network switch to the second network switch over the network link during said transmitting the first one or more packet flows, wherein the separate packet flow is not transmitted on a virtual channel.

20. The method as recited in claim 1, wherein the first one or more packet flows include at least one packet flow comprising storage packets.

21. The method as recited in claim 1, wherein the first one or more packet flows include at least one packet flow comprising Storage over Internet Protocol (SoIP) packets each encapsulating one or more Fibre Channel packets.

22. The method as recited in claim 1, wherein the network link supports Gigabit Ethernet, and wherein the first one or more packet flows include at least one packet flow comprising one or more Gigabit Ethernet packets.

23. A method comprising:
establishing one or more virtual channels on a network link between a first network switch and a second network switch;
initializing credit-based flow control credits for each of the one or more virtual channels;
transmitting a first one or more packet flows from the first network switch to the second network switch on the one or more virtual channels, wherein each of the first one or more packet flows is transmitted on a corresponding one of the plurality of virtual channels; and
performing credit-based flow control for each of the first one or more packet flows on the corresponding virtual channel;
wherein the first one or more packet flows includes at least one packet flow comprising storage packets.

24. The method as recited in claim 23, wherein, in said performing the credit-based flow control, the credits are maintained for each of the one or more virtual channels to reduce packet loss from the first one or more packet flows and to distribute resources among the one or more virtual channels on each of the two network switches.

25. The method as recited in claim 23, further comprising:
transmitting a second one or more packet flows from the second network switch to the first network switch on the one or more virtual channels, wherein each of the second one or more packet flows is transmitted on a corresponding one of the plurality of virtual channels; and
performing credit-based flow control for each of the second one or more packet flows on the corresponding virtual channel.

26. The method as recited in claim 23, further comprising transmitting a separate packet flow from the first switch to the second switch over the network link during said transmitting the first one or more packet flows, wherein the separate packet flow is not transmitted on a virtual channel.

27. The method as recited in claim 23, wherein the network link supports Gigabit Ethernet, and wherein the first one or more packet flows includes at least one packet flow comprising Gigabit Ethernet packets.

28. A method comprising:
establishing a plurality of virtual channels on a Gigabit Ethernet link between a first network switch and a second network switch; and
transmitting a first plurality of Storage over Internet Protocol (SoIP) packets each encapsulating one or more Fibre Channel packets from the first network switch to the second network switch on a first of the one or more virtual channels;
wherein credit-based flow control is performed for the first virtual channel to reduce packet loss from the first plurality of SoIP packets.

29. The method as recited in claim 28, further comprising:
transmitting a second plurality of Storage over Internet Protocol (SoIP) packets each encapsulating one or more Fibre Channel packets from the second network switch to the first network switch on a second of the one or more virtual channels;
wherein credit-based flow control is performed for the second virtual channel to reduce packet loss from the second plurality of SoIP packets.

30. A network switch comprising:
one or more ports for sending and receiving packets;
packet transport logic configured to:
establish one or more virtual channels on a network link between one of the one or more ports on the network switch and another network switch;
determine a number of credits allocated for each of the one or more virtual channels on the network link;
transmit a first one or more packet flows to the other network switch, wherein each of the first one or more packet flows is transmitted on a corresponding one of the plurality of virtual channels; and
perform credit-based flow control for each of the first one or more packet flows on the corresponding virtual channel using the number of credits allocated for the corresponding virtual channel on the network link.

31. The network switch as recited in claim 30, wherein, after said determining the number of credits allocated for each of the one or more virtual channels on the network link, the packet transport logic is further configured to:
receive a second one or more packet flows from the other network switch, wherein each of the second one or more packet flows is transmitted on a corresponding one of the plurality of virtual channels; and
perform credit-based flow control for each of the second one or more packet flows on the corresponding virtual channel, wherein said credit-based flow control for the particular packet flow uses the number of credits allocated for the corresponding virtual channel on the network link.

32. The network switch as recited in claim 30, wherein, in said establishing the one or more virtual channels on the network link, the packet transport logic is further configured to:
send one or more login frames to the other network switch; and
receive one or more login acknowledgement frames from the other network switch in response to the one or more login frames sent from the network switch;
wherein each of the one or more login frames includes at least one of a requested number of egress virtual channels that the network switch desires to establish on the network link, a supported number of ingress virtual channels supported by the network switch on the network link, a requested egress packet size for each of the egress virtual channels that the network switch desires to establish on the network link, and a supported ingress packet size for each of the ingress virtual channels supported by the network switch on the network link.

33. The network switch as recited in claim 30, wherein, in said establishing the one or more virtual channels on the network link, the packet transport logic is further configured to:
determine a number of egress virtual channels and a number of ingress virtual channels that are supported by the network switch on the network link;
wherein the number of egress virtual channels supported on the network switch is equal to a number of ingress virtual channels supported on the other network switch, and wherein the number of ingress virtual channels supported on the network switch is equal to a number of egress virtual channels supported on the other network switch.

34. The network switch as recited in claim 30, wherein the packet transport logic is further configured to:
calculate an egress packet size and an ingress packet size for each of the one or more virtual channels on the network switch;
wherein the egress packet size for each of the one or more virtual channels on the network switch is equal to an ingress packet size for the corresponding virtual channel on the other network switch, and wherein the ingress packet size for each of the one or more virtual channels on the network switch is equal to an egress packet size for the corresponding virtual channel on the other network switch.

35. The network switch as recited in claim 30, wherein, in said determining the number of credits allocated for each of the one or more virtual channels on the network link, the packet transport logic is further configured to:
send one or more credit initialization frames to the other network switch, wherein the one or more credit initialization frames each include information on an allocated number of credits on the network switch for each of the one or more virtual channels supported on the network link; and
receive one or more credit initialization acknowledgement frames from the other network switch in response to the one or more credit initialization frames sent from the network switch.

36. The network switch as recited in claim 30, wherein, in said determining the number of credits allocated for each of the one or more virtual channels on the network link, the packet transport logic is further configured to determine the number of credits allocated on the other network switch for each of the one or more virtual channels on the network link.

37. The network switch as recited in claim 30, wherein, in said performing credit-based flow control, the packet transport logic is further configured to track credit usage for each of the one or more virtual channels on the network switch.

38. The network switch as recited in claim 37, wherein, in said performing credit-based flow control, the packet transport logic is further configured to stop a packet flow on one of the one or more virtual channels if available credits for the packet flow on the virtual channel drop to zero.

39. The network switch as recited in claim 37, wherein, in said performing credit-based flow control, the packet transport logic is further configured to synchronize the tracking of credit usage for each of the one or more virtual channels between the network switch and the other network switch.

40. The network switch as recited in claim 39, wherein, in said synchronizing, the packet transport logic is further configured to:
send a credit synchronization message to the other network switch, wherein the credit synchronization message includes a current number of unused credits for each of the one or more virtual channels being supported in the egress direction on the network switch;
receive a credit synchronization acknowledgement message from the other network switch in response to the credit synchronization message, wherein the credit synchronization acknowledgement message includes:
a current number of unused credits for each of the one or more virtual channels being supported in the ingress direction on the other network switch; and
the current number of unused credits for each of the one or more virtual channels received in the credit synchronization message; and
update the current number of unused credits for each of the one or more virtual channels being supported in the egress direction on the network switch using the current number of unused credits for the particular virtual channel being supported in the ingress direction on the other network switch received in the credit synchronization acknowledgement message and the current number of unused credits for the particular virtual channel received in the credit synchronization acknowledgement message.

41. The network switch as recited in claim 30, wherein, in said performing credit-based flow control, the packet transport logic is further configured to receive a virtual channel ready frame from the other network switch, wherein the virtual channel ready frame indicates available credits on the other network switch for receiving packets on the one or more virtual channels.

42. The network switch as recited in claim 30, wherein the packet transport logic is further configured to transmit a separate packet flow from the network switch to the other network switch over the network link during said transmitting the first one or more packet flows, wherein the separate packet flow is not transmitted on a virtual channel.

43. The network switch as recited in claim 30, wherein the first one or more packet flows include at least one packet flow comprising Storage over Internet Protocol (SoIP) packets each encapsulating one or more Fibre Channel packets.

44. The network switch as recited in claim 30, wherein the network link supports Gigabit Ethernet, and wherein the first one or more packet flows include at least one packet flow comprising one or more Gigabit Ethernet packets.

45. A network comprising:
a first network switch comprising one or more ports for sending and receiving packets; and
a second network switch comprising one or more ports for sending and receiving packets;
wherein the first network switch is configured to:
establish a Gigabit Ethernet link between a first port on the first network switch and a second port on the second network switch;
establish a plurality of virtual channels on the Gigabit Ethernet link; and
transmit a first one or more packet flows comprising Storage over Internet Protocol (SoIP) packets each encapsulating one or more Fibre Channel packets to the second network switch on a first of the one or more virtual channels.

46. The network as recited in claim 45, wherein the first network switch is further configured to perform credit-based flow control for the first virtual channel.

47. The network as recited in claim 45, wherein the second network switch is configured to:
transmit a second one or more packet flows comprising SoIP packets each encapsulating one or more Fibre Channel packets to the first network switch on a second of the one or more virtual channels; and
perform credit-based flow control for the second virtual channel.

48. A network comprising:
a first network switch comprising one or more ports for sending and receiving packets; and
a second network switch comprising one or more ports for sending and receiving packets;
wherein the first network switch is configured to:
establish a network link between a first port on the first network switch and a second port on the second network switch;
establish one or more virtual channels on the network link;
initialize credit-based flow control credits for each of the one or more virtual channels;
transmit a first one or more packet flows to the second network switch on the one or more virtual channels, wherein each of the first one or more packet flows is transmitted on a corresponding one of the plurality of virtual channels; and
perform credit-based flow control for each of the first one or more packet flows on the corresponding virtual channel.

49. The network as recited in claim 48, wherein the first network switch is further configured to:
receive a second one or more packet flows from the second network switch on the one or more virtual channels, wherein each of the second one or more packet flows is received on a corresponding one of the plurality of virtual channels; and
perform credit-based flow control for each of the second one or more packet flows on the corresponding virtual channel.

50. The network as recited in claim 48, wherein the first one or more packet flows include at least one packet flow comprising Storage over Internet Protocol (SoIP) packets.
